(19) United States
(12) Patent Application Publication
(10) Pub. No.: US 2004/0178384 A1
(43) Pub. Date: Sep. 16, 2004

(54) Heat-generating composition, heater made using heat-generating composition, and process for producing the same

(76) Inventor: Kaoru Usui, Tochigi (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/386,723

(22) Filed: Mar. 13, 2003

(51) Int. Cl. C09K 5/00

(52) U.S. Cl. 252/76

(57) ABSTRACT

A sherbet-like heat-generating composition according to the present invention includes, as requisite components, an exothermic substance suitable to react with oxygen to generate a heat, a carbon component, an oxidation promoter and water, so that the water mobility value is in a range of 7 to 50. A heater having any shape is produced from such a sherbet-like heat-generating composition at any thickness and any size by use of a molding means such as the screen printing, the coating, the transferring, the force-in die molding, the force-through die molding and the like. During the production of the heater, the generation of a dust can be prevented, and after the production, the heater has an excellent heat-generating characteristic. An initial reaction in the heater is fast and can be maintained over a long time.

### BACKGROUND OF THE INVENTION

1. Field of the Invention

The present invention relates to a heat-generating composition capable of being molded into any shape such circular, elliptical and dumbbell shapes at any thickness in a range of an extremely small value to a larger value; to a heater produced using such a heat-generating composition; and to a process for producing the same. More particularly, the present invention relates to a heat-generating composition which is excellent in heat-generating performance, which is capable of being molded into a sherbet-like state as a whole using an exothermic substance, a carbon component, an oxidation promoter and water as requisite components by setting a water mobility value in a range of 7 to 50, and which is capable of being dispersed at a uniform thickness into a bag; to a heater which is soft and remarkably excellent in feeling of use, which is capable of generating a heat over a longer time, and which is capable of being produced at any thickness in a range of an extremely small value to a larger value, any of various sizes and any of various shapes such as circular, prolong and triangular shapes from such a sherbet-like heat-generating composition, using a through-type die mounted on a substrate; and to a process for producing such a heater.

2. Description of the Related Art

A heat-generating composition prepared utilizing an oxidizing reaction of a metal such as iron and the like has been provided in a viscous or creamy state using a powder, a binder, a thickener and the like. A heater produced using such a heat-generating composition is very excellent in respect of a cost, a stability and a heat-generating temperature, and has already been put into practical use, for example, as a so-called chemical body warmer in a state in which it has been packed in a bag having an air-permeability.

In addition, such a heater has been utilized as a heater for a footwear such as shoes and slippers by forming a bag having an air-permeability into a horse shoe shape or an trapezoidal shape to change the shape of a body warmer. On the other hand, it has been proposed that a heat-generating material is formed in a viscous or creamy state into a foot shape or a circular shape rather than the conventional rectangular shape, so that the shape is suitable for the profile of an object to be warmed, as disclosed in Japanese Patent Application Laid-open No.S60-101448, H10-216167 and H11-508314 and the like.

There is a conventionally proposed process for producing such a heater, which comprises subjecting a heat-generating composition in a slurry state, a coagulation state or a viscous state to a compression molding, throwing the molded heat-generating composition onto a predetermined region on a substrate, placing a covering member having an air-permeability on the heat-generating composition, and sealing entire peripheral edges of the substrate and the covering member by a heat sealing or a hot-melt type adhesive.

A heater produced in the above manner is sealed and preserved in an outer bag having an air-tightness in order to inhibit the exothermic reaction thereof till the use and service thereof, and is put into circulation market.

It has been also proposed that when a heat-generating composition is creamy, a thickener is added to the heat-generating composition to provide a consistency to the heat-generating composition, thereby bringing the heat-generating composition into a creamy state; the heat-generating composition is laminated on a water-absorbable support such as a paper and the like by the printing, the coating or the like to produce a thin heater; and free water and/or a portion of water hydrated gel is absorbed into the support, a covering member or the like, whereby the contact of the heat-generating composition with air is improved to start an exothermic reaction.

When a heat-generating composition is powdery, typical of a method for throwing the heat-generating composition are a method for throwing the powdery heat-generating composition during stoppage of a bag substrate which is intermittently moved, as found in a method for packing the heat-generating composition into an accommodating bag, and a method for throwing the powdery heat-generating composition onto a substrate through a throwing port, while moving the substrate at a constant speed, as found when the powdery heat-generating composition is dispersed into a non-woven fabric, and water is added to produce a sheet-shaped heater.

However, these powdery heat-generating compositions suffer from various disadvantages. More specifically, when the heater is used for heating a human body or a mechanical equipment or keeping it warm, the heat-generating composition is offset to a lower portion of the bag by the force of gravity not only in a moving state but also in a state of rest, thereby producing a sense of incompatibility due to a variation in shape and moreover, resulting in a variation in heat-generating characteristic itself to reduce the amount of heat generated.

Further, when the powdery heat-generating composition is packed into the accommodating bag to produce the heater, the substrate is moved intermittently, and the heat-generating composition is thrown onto the substrate during stoppage of the substrate. For this reason, the following problem is encountered: the producing speed is reduced, because the stoppage and movement of the substrate are repeated frequently.

Especially, when a thin heater is intended to be produced, an unevenness in thickness, namely, a variation in amount of heat-generating composition packed is produced, and as a result, the reliability of heat generation is lost. In order to increase the reliability, it is required that the entire heater is made thicker on the order of several millimeters. For this reason, the feeling of use is detracted in respect of the form. In addition, the movement of the heat-generating composition occurs and as a result, the heat-generating temperature profile is not constant and thus, the feeling of use is also detracted in respect of the characteristic.

On the other hand, there is a conventionally known heater formed so that the offsetting of a heat-generating composition is prevented utilizing a depressurization during generation of a heat by a porous film. However, the complete prevention of the offsetting is not reached.

In the method for throwing the heat-generating composition onto the substrate, while moving the substrate at the constant speed, as found in the manufacture of the sheet-shaped heater, there is a possibility that an increase in speed is provided by the method for packing the powdery heat-generating composition, but it is necessary to disperse the powdery heat-generating composition in a non-woven fabric as the substrate and hence, the manufacture speed has a limit.

On the other hand, the slurry-like heat-generating composition contains a large content of water and for this reason, the shape of the slurry-like heat-generating composition cannot be maintained. The viscous heat-generating composition is insufficient in fluidity and is difficult to mold and hence, a compression molding or the like is obliged to be relied on.

Ink-like and cream-like heat-generating compositions have been developed, in which a thickener is added to a heat-generating composition to provide a consistency to the heat-generating composition in imitation of an ink containing a glue, an acacia rubber or the like and a cream containing CMC or the like, there by enabling the printing of the heater. However, the ink-like and cream-like heat-generating compositions are excellent in respect of the prevention of the offsetting, the moldability and the maintaining of the shape, because the thickener is used to bond particles of the heat-generating composition, but the heat-generating performance thereof is remarkably poor. A viscous heat-generating composition produced using a thickener and a binder is also excellent in respect of the prevention of the offsetting, the moldability and the maintaining of the shape, because the thickener and the binder are used to bond particles of heat-generating composition, but the heat-generating performance is remarkably poor.

In the case of the viscous heat-generating composition, a compression molding step is included for the shaping purpose, resulting in complicated steps. On the other hand, in the case of the ink-like and cream-like heat-generating compositions, the shaping of the heat-generating composition can be achieved at a high speed by a printing process or the like, because the thickener is added to provide the consistency to the heat-generating composition. However, even if free water is absorbed into the support, the covering member or a water-absorbing material to cause an exothermic reaction, the free water is not withdrawn up, because the heat-generating composition is consistent attributable to the binder, the thickener, a coagulation assistant and a water-absorbable polymer, and the reaction is sluggish or slow due to an adverse influence exerted to the exothermic substance by the thickener and the like. Thus, it is difficult to rapidly raise the temperature to a required level and to warm an object for a longer time.

Further, the cream-like heat-generating composition is accompanied by a problem that it is ill drained and for this reason, a longer time is required for absorbing the free water into the support and the like, and a surplus amount of free water is left in the heat-generating composition to obstruct the reaction. If the amount of water added is decreased, there is a problem that the exothermic reaction time is shortened and the like. Therefore, it is possible to form a ultra-thin heater at a high speed, but the generation of a heat for a longer time is impossible. If the heater is intended to be formed thicker to prolong the heat-generating time, the free water is not withdrawn up and on the contrary, the heat-generating temperature is dropped. This is a problem for the production of a heater capable of providing a desired temperature and a desired heat-generating time.

The present inventors have found that if an attempt is made to add a surplus amount of water to a powdery heat-generating composition comprising a heat-generating composition containing a substance having a viscosity such as a water-absorbable polymer, a coagulation assistant, a thickener and a binder or a substance for revealing a viscosity if it is mixed with water, and an amount of water suitable for an exothermic reaction, thereby controlling the heat generation by the surplus amount of water, the heat generation can be controlled, but the heat-generating characteristic is detracted remarkably, and a desired heat-generating characteristic cannot be provided.

The present inventors has also found that a moldability such as a shapability is provided by regulating the amount of free water rather than a viscosity-increasing method using a thickener, a binder, accumulation assistant, a water-absorbable polymer and/or the like.

The following has been also found: The principle of the generation of a heat in a disposable body warmer or the like is to utilizing the generation of a heat when a metal powder is oxidized. The oxidizing reaction is especially influenced by the amount of water. Even if the amount of water is either too large or too small, the reaction is remarkably slow. Thus, an amount of water suitable for starting and maintaining the heat generation is required, but it is preferable that free water is removed to the utmost. Therefore, it has been found that when the free water is utilized in order to provide the moldability, if a composition in which free water is easily discharged is prepared, or if water is absorbed by a water absorbent, a substrate or the like, or the amount of free water is reduced by leaving the composition to stand in a space or by depressurizing the composition, under the elimination of an adverse influence exerted to the exothermic substance by a viscosity-providing substance such as a thickener, a binder, a coagulation assistant, a water-absorbable polymer and the like, the heat generation can be started with a good efficiency, and an excellent heat-generating characteristic is shown.

Further, the present inventors have found that if the heat-generating composition is formed in to a sherbet-like state, it is very easy to discharge free water and to laminate the heat-generating composition by a force-through die molding, a force-in die molding, a screen printing, a coating or the like, and it is possible to produce ultra-thin and thick heaters at a high speed. Moreover, the heat-generating composition can be dispersed uniformly in a bag and moreover, if the heat-generating composition is laminated on an absorbable substrate, the sherbet-like heat-generating composition has high entering and anchoring properties, and bites into pores in the substrate, whereby the movement and offsetting thereof are inhibited. If the water absorbability is increased, its effect is increased.

Yet further, it has been found that if the sherbet-like heat-generating composition is stirred or vibrated, the surplus amount of water is separated, whereby the flowability of the heat-generating composition is enhanced, leading to a remarkable enhancement in moldability.

Yet further, it has been found that if a magnet is utiized, the sherbet-like heat-generating composition can be easily accommodated into a die, and after the accommodation, sherbet-like heat-generating composition can be molded by removing the magnet and further removing the die, and the shape thereof can be maintained. In other words, the molding of the sherbet-like heat-generating composition accompanied by the shaping and the shape retention can be easily achieved by a combination of the flowability of the sherbet-like heat-generating composition with the magnet and hence, a heater having any shape and an excellent heat-generating characteristic can be produced.

As described above, the conventional heat-generating composition utilizing an oxidation heat-generating phenomenon has the above-described problems and hence, the developments of a heat-generating composition and a heater have been expected, the heater being harmless and easy to use and capable of being produced into any shape and at any thickness and size, and having an excellent heat-generating characteristic such that the initial reaction of the heater is fast and can be continued for a long time.

Therefore, the present inventors have made zealous studies and various systematic experiments to solve the problems associated with the prior art and as a result, they have reached the accomplishment of the present invention.

Namely, the present inventors has succeeded in developing a heat-generating composition which is capable of being formed into a sherbet-like state as a whole, using an exothermic substance reacting with oxygen to generate a heat, a carbon component, an oxidation promoter and water as requisite components with a water mobility value limited within a given range without use of a thickener, a binder, a coagulation assistant and a viscosity-providing substance such as a water-absorbable polymer; which has a flowability, a moldability, a shape-maintaining property, a non-consistency and a high draining property for a surplus amount of water such as free water; which has a moldability and a shape-retaining property incapable of being realized in the prior art, when it is in a powdery state; and which has an excellent moldability and an excellent heat-generating characteristic incapable of being realized in the prior art, when it is in a creamy state or in a slurry state. In a heater produced using such heat-generating composition, a surplus amount of water is discharged with a good efficiency out of the heat-generating composition and hence, the heater is capable of exhibiting a higher heat-generating temperature and has a longer heat-generation life.

If a substance having a viscosity is mixed into the heat-generating composition, the moldability and the shape-maintaining property are improved, but the draining property and heat-generating property are degraded. Therefore, a sherbet-like heat-generating composition having an excellent heat-generating characteristic could be realized according to the present invention by ensuring that a substance having a viscosity or exhibiting a viscosity when it is mixed with water, is not contained in the heat-generating composition.

Of course, any of a thickener, a binder, a coagulation assistant, a water-absorbable polymer, a water absorbent and a water-absorbing material may be provided on a surface or back of the molded heat-generating composition. After a surplus amount of water has been removed out of the heat-generating composition to provide a heat-generatable state, any of such additives may be mixed with the heat-generating composition.

In addition, a heater could be molded into any shape and with any thickness and size, using a molding means such as a printing process such as a screen printing and a coating, a transferring process, a force-in die molding process, a force-through die molding process and the like. In this case, a magnet can be also used. The magnet may be of any type, if it has a magnetic property, and examples thereof are a permanent magnet and an electromagnet.

Since the heat-generating composition is formed into the sherbet-like state to solve the above-described problems, the flowability and the moldability are provided to the heat-generating composition. Thus, the moldability and the shape-maintaining property are enhanced greatly,as compared with the slully-shaped heat-generating composition, thereby enabling a push-out die molding or the like at a high speed to produce heaters in non-continuous forms and in continuous forms into any of various shapes such as a planar shape, a circular shape and the like at any thickness in a range of a extremely small value to a larger value and at any area in a range of a smaller value to a larger value.

No adverse influence is exerted to the exothermic substance by the binder and/or the thickener, and the heat-generating composition has no consistency. Therefore, the heat-generating composition has a good water-permeability such that free water in the molded heat-generating composition is discharged quickly out of the heat-generating composition. Thus, it is possible to produce a chemical body warmer in which the temperature-raising speed, the reached temperature and the heat-generating time are increased remarkably, as compared with a case where the binder and the like are used (in the viscous state or in the creamy state), and which is capable of exhibiting a heat-generating performance nearer to that of a heater produced from a powdery heat-generating composition. The present invention has been completed by obtaining the above-described knowledges.

### SUMMARY OF THE INVENTION

Accordingly, it is an object of the present invention to provide a heat-generating composition capable of being molded using a molding means such as a printing process such as a screen printing and a coating, a transferring process, a force-in die molding process, a force-through die molding process; a heater which can be produced into any shape and at any size and any thickness using such a heat-generating composition, while preventing the generation of a dust, which has an excellent heat-generating characteristic, whose initial exothermic reaction is fast and can be continued for a long time; and a process for producing such a heater.

To achieve the above object, according to a first aspect and feature of the present invention, there is provided a heat-generating composition comprising, as requisite components, an exothermic substance suitable to react with oxygen to generate a heat, a carbon component, an oxidation promoter and water, so that the water mobility value is in a range of 7to 50.

According to a second aspect and feature of the present invention, in addition to the first feature, a volcanic ash material is incorporated in the heat-generating composition.

According to a third aspect and feature of the present invention, in addition to the first or second feature, a water-retaining agent is incorporated in the heat-generating composition.

According to a fourth aspect and feature of the present invention, in addition to the first feature, at least one component selected from a pH adjustor, a hydrogen inhibitor, a surfactant, an antifoaming agent, a hydrophobic polymer compound, a pyroelectric material, a far infrared ray emitting substance, an antioxidant, an aggregate and a heat-generating assistant is incorporated in the heat-generating composition.

According to a fifth aspect and feature of the present invention, in addition to the fourth feature, the hydrophobic polymer compound is a polymer compound having an angle of contact with water equal to or larger than 40°.

According to a sixth aspect and feature of the present invention, there is provided a heater comprising a heat-generating composition according to the first feature, which is accommodated sealedly in a stratified configuration in an accommodating bag having an air-permeability at least partially, and a portion of water in the heat-generating composition is absorbed into the accommodating bag.

According to a seventh aspect and feature of the present invention, in addition to the sixth feature, the accommodating bag comprises a substrate in the form of a film, a sheet or a non-woven fabric and a covering member in the form of a film, a sheet or a non-woven fabric, at least a portion of the substrate or the covering member having an air-permeability and a water-absorbability.

According to an eighth aspect and feature of the present invention, there is provided a heater comprising a heat-generating composition according to the first feature, which is accommodated in an accommodating bag in a state in which it has been laminated on a underlay member, the accommodating bag being comprised of a substrate and a covering member, at least a portion of the components constituting the accommodating bag having an air-permeability.

According to a ninth aspect and feature of the present invention, in addition to the eighth feature, the heat-generating composition is accommodated in the accommodating bag in a state in which at least a portion of water in the heat-generating composition has been discharged to an extent substantially enough to be able to generate a heat in the atmospheric air, in at least one of such a manner that the composition is left to stand in a space, or compressed, depressurized or compressed and depressurized, and such a manner that the water is absorbed by a material such as the water-absorbable substrate or by a water absorbent, after the lamination of the heat-generating composition on the underlay member in the form of a film, a sheet or a non-woven fabric.

According to a tenth aspect and feature of the present invention, in addition to either of the sixth or seventh features, at least one component selected from an iron powder, a carbon component, a water absorbent, a water-absorbable polymer, a binder, a thickener and a coagulation assistant is laminated or scattered on one side or opposite sides of the heat-generating composition.

According to an eleventh aspect and feature of the present invention, in addition to either of the sixth or seventh features, at least a portion of the surface of the heat-generating composition is covered with a network polymer.

According to a twelfth aspect and feature of the present invention, in addition to either of the sixth or seventh features, the substrate and the covering member are sealed entirely or partially at a peripheral portion of the heat-generating composition in a stuck manner, an adhered manner or a thermally fused manner.

According to a thirteenth aspect and feature of the present invention, in addition to either of the sixth or seventh features, the substrate and/or the covering member is formed of a water-absorbing material in the form of a film, a sheet or a non-woven fabric having a water-absorbability.

According to a fourteenth aspect and feature of the present invention, in addition to the eight features, a water-absorbing layer formed of a water-absorbing material or a water absorbent is provided at least at a portion of the substrate or the covering member or the underlay member, which is in contact with the heat-generating composition.

According to a fifteenth aspect and feature of the present invention, in addition to either of the eighth or fourteenth features, each of the substrate, the covering member and the water-absorbing layer has a water-absorbing power equal to or larger than 1 g/m².

According to a sixteenth aspect and feature of the present invention, in addition to the eighth features, at least one of the substrate, the covering member and the underlay member has a stretching property.

According to a seventeenth aspect and feature of the present invention, in addition to either of the sixth or seventh features, the whole or a portion of a surface layer of the heat-generating composition is formed into a rugged shape.

According to an eighteenth aspect and feature of the present invention, in addition to the seventeenth feature, the rugged shape is formed by grooves or holes of a continuous or non-continuous pattern, or a combination of them.

According to a nineteenth aspect and feature of the present invention, in addition to either of the sixth or seventh features, the whole or a portion of at least the heat-generating composition and a surface layer of a material to which the heat-generating composition is laminated, is formed into a rugged shape.

According to a twentieth aspect and feature of the present invention, in addition to the nineteenth feature, the rugged shape is formed by grooves or holes of a continuous or non-continuous pattern, or a combination of them.

According to a twenty first aspect and feature of the present invention, in addition to either of the sixth or seventh features, a self-adhesive layer or a gel layer is laminated at least on a portion of an exposed surface of either the substrate or the covering member.

According to a twenty second aspect and feature of the present invention, in addition to the twenty first feature, the self-adhesive layer or the gel layer is a wet compress layer containing a wet compress drug, or a drug-containing layer containing or carrying an endermically absorbable drug.

According to a twenty third aspect and feature, there is provided a process for producing a heater, comprising the steps of subjecting a heat-generating composition according to the first feature to a molding such as the lamination on at least one predetermined region on a substrate in the form of a film, a sheet or a non-woven fabric, and placing a covering member in the form of a film, a sheet or a non-woven fabric to cover the heat-generating composition, so that at least a portion of the substrate or the covering member has an air-permeability.

According to a twenty fourth aspect and feature of the present invention, there is provided a process for producing a heater, comprising the steps of laminating a heat-generating composition according to the first feature on at least one predetermined region on a substrate in the form of a film, a sheet or a non-woven fabric, laminating or scattering at least one component selected from an iron powder, a carbon component, a ceramic powder emitting far infrared rays, a fiber emitting far infrared rays, a water absorbent, a water-absorbing material, a water-absorbable polymer, a binder, a thickener and a coagulation assistant on at least one of upper and lower surfaces of the heat-generating composition, and placing a covering member in the form of a film, a sheet or a non-woven fabric to cover the heat-generating composition and the at least one component selected from the iron powder, the carbon component, the ceramic powder emitting far infrared rays, the fiber emitting far infrared rays, the water absorbent, the water-absorbing material, the water-absorbable polymer, the binder, the thickener and the coagulation assistant, so that at least a portion of the substrate or the covering member has an air-permeability.

According to a twenty fifth aspect and feature of the present invention, there is provided a process for producing a heater, comprising the steps of laminating a heat-generating composition according to the first feature on a substrate in the form of a film, a sheet or a non-woven fabric, placing a network polymer on the heat-generating composition, placing a covering member in the form of a film, a sheet or a non-woven fabric on the network polymer, affixing the substrate and the covering member to each other by the network polymer, and punching the resulting laminate into any shape, so that at least a portion of the substrate or the covering member has an air-permeability.

According to a twenty sixth aspect and feature of the present invention, there is provided a process for producing a heater, comprising the steps of laminating a heat-generating composition according to the first feature on a member in the form of a non-woven fabric, covering the resulting laminate by a member in the form of a non-woven fabric, dehydrating the heat-generating composition in a sucking, centrifugal, compressing, depressurizing, or compressing and depressurizing manner and affixing the members to each other to provide a laminate, punching the laminate into any shape, placing the laminate on a substrate, placing a covering member in the form of a film, a sheet or a non-woven fabric onto the laminate, fusing the substrate and the covering member to each other at their peripheral portions, and punching the resulting laminate into any shape, so that at least a portion of the substrate or the covering member has an air-permeability.

According to a twenty seventh aspect and feature of the present invention, there is provided a process for producing a heater, comprising the steps of interposing a heater according to the sixth or seventh feature between two films or sheets, punching the two films or sheets into a size larger than that of the heater simultaneously with or after the interposition, and sealing the two films or sheets at a peripheral edge of the heater simultaneously with or after the punching.

As described above, the heat-generating composition according to the present invention is formed into the sherbet-like state using a surplus amount of free water without substantial use of a viscosity-providing substance such as a water-absorbent, a water-absorbable polymer, a binder, a thickener or a coagulation assistant, so that a heat-generating property, a moldability and a shape-maintaining property can be exhibited. Therefore, the following effects are provided:

(1) The sherbet-like heat-generating composition according to the present invention has a moderate flowability and hence, can be laminated in a controlled manner at a high accuracy on a substrate by the printing, the coating, the force-through die molding or the force-in die molding. Therefore, heaters having a large thickness to a ultra small thickness can be produced at a high speed.

(2) Because the sherbet-like heat-generating composition according to the present invention has the moderate flowability, it can be laminated in any of various shapes on the substrate by the printing, the coating, the force-through die molding or the force-in die molding, and the shape thereof can be maintained. Therefore, heaters having various shapes can be produced.

(3) Because the sherbet-like heat-generating composition according to the present invention does not contain a viscosity-providing substance such as a water-absorbent, a water-absorbable polymer, a binder, a thickener or a coagulation assistant, an excessive amount of water or free water can be absorbed easily into the substrate, the underlay member or the covering member and further into the water-absorbing layer after the molding of the heat-generating composition. Therefore, it is possible to produce a heater having an excellent heat-generating characteristic with a surplus amount of water such as free water removed.

(4) The sherbet-like heat-generating composition according to the present invention is excellent in its discharging property for water such as free water and hence, the water is absorbed into the substrate. Therefore, an anchoring effect of the heat-generating composition is increased, and a force of adhesion of the heat-generating composition to the substrate is increased.

(5) Because the sherbet-like heat-generating composition according to the present invention is excellent in its discharging property for water such as free water, the water such as the discharged water from the substrate is also supplemented to a heater produced after the molding of the heat-generating composition. Thus, the heat-generating time can be prolonged.

(6) If the sherbet-like heat-generating composition according to the present invention is used, a heater can be formed into a sheet shape. Therefore, a powder cannot be flied, and the heater can be cut into any shape in conformity to the shape and size of an object to be kept warm.

(7) If the sherbet-like heat-generating composition according to the present invention is used, a heater can be produced in a ultra-thin structure with the heat-generating composition laminated uniformly, and has an excellent heat-generating performance. Therefore, the heater is ultra-thin and high in its softness, leading to an extremely good followability to a curved portion or a bent portion of a human body such as a shoulder, and leading to an effect of providing an excellent feeling of use. In addition, the heater can be mounted tightly on any of equipments to warm them.

(8) When the substrate and the covering member in the heater according to the present invention has a stretching property, especially, an expandable/contractible properties, the heater can be conformed further easily to a complicated rugged shape of any portion. Moreover, the followability to a variation in rugged shape due to the movement of the human body is enhanced, whereby the peeling-off of the heater and the lifting-up of the heater from a portion to which the heater has been applied are prevented reliably, and the close contact with the human body is improved to provide an excellent warming effect and a blood circulation promoting effect.

(b 9) When the substrate and/or the covering member or the water-absorbent in the heater according to the present invention have a water-absorbability, the following effect is provided: A portion of water in the heat-generating composition can be absorbed before the use of the heater, whereby the content of water in the heat-generating composition can be adjusted to a level suitable for the generation of a heat. As a result, the heat generation can be started immediately by breaking the air-tight bag for purpose of putting the heater into service, and a required heat-generating temperature can be provided immediately. Moreover, the water evaporated from the heat-generating composition can be released for supplementation through the substrate and covering member, and the required heat-generating temperature can be maintained over a long time.

(10) If at least one component selected from a far infrared ray emitting material, a magnet and an endermically absorbable drug is contained in or carried on a self-adhesive layer, a far infrared ray warming effect, a far infrared ray therapeutic effect, a magnetic therapeutic effect and/or a drug therapeutic effect is provided, but also these effects are promoted and enhanced synergistically with systematically and partially blood circulation promoting actions attributable to the generation of the heat by the heater.

(11) In the first process according to the present invention, the sherbet-like heat-generating composition according to the present invention can be formed and laminated with the laminated region controlled at a high accuracy, at a very small thickness and uniformly on the substrate by the transferring and the printing. As a result, the heaters having a ultra-thin structure to a thicker structure can be produced at a high speed. In this case, a vibration may be applied to a head, a die-pushing plate to smoothen the molding. Namely, the sherbet-like heat-generating composition can be laminated in such a manner that it is passed through a die, while being vibrated. The vibration promotes the fluidization of the heat-generating composition to uniformize the surface of the laminate. Moreover, the heat-generating composition can be laminated on the substrate by the transferring or the printing, using a surplus small amount of water, with the laminated region controlled at a high accuracy, at a very small thickness and uniformly. As a result, the heater having a ultra-thin structure and an excellent heat-generating characteristic can be produced at a high speed.

(12) In the second process according to the present invention, the heat-generating composition according to the present invention, namely, the sherbet-like heat-generating composition can be formed with an increased content of water. The heat-generating composition is laminated on at least one predetermined region on an upper surface of a film-shaped or a sheet-shaped substrate, and at least one component selected from an iron powder, a carbon component or a water-absorbent is then laminated or scattered on the upper surface of the heat-generating composition according to the present invention. Thus, it is possible to provide an effect of improving the starting of the heat generation at an initial stage of the service of the heater and an effect of enhancing the temperature characteristic.

(13) In the third process according to the present invention, a sherbet-like heat-generating composition according to the present invention is passed through a die and laminated on a film-shaped or sheet-shaped substrate, and a tacky substance is mounted on the heat-generating composition by a melt-blow process or the like. A film-shaped or a sheet-shaped covering member is placed on the heat-generating composition having the tacky substance mounted thereon, whereby the substrate and the covering member are affixed to each other. Then, the resulting laminate is punched into any shape, and at least one of the substrate and the covering member or a portion of the at least one has an air-permeability. Therefore, the sherbet-like heat-generating composition can be distributed uniformly and fixed within a bag, whereby the movement and offsetting of the heat-generating composition can be prevented. As a result, an excessive exothermic reaction of the heat-generating composition can be avoided to the utmost to prevent a low-temperature burn of a human body, and a heater according to the present invention capable of being used safely can be produced.

(14) In the fourth process according to the present invention, a sherbet-like heat-generating composition according to the present invention is formed and laminated on a substrate having an air-permeability such as a non-woven fabric by the transferring or the printing. A surplus amount of water is discharged by the depressurizing hydration or the like, and a water-absorbing material of cotton or the like is scattered on the heat-generating composition, and a tacky substance is mounted in a net shape by a melt-blow process. Then, a film-shaped or sheet-shaped covering member is placed on the laminate, whereby the substrate and the covering member are affixed to each other. Then, the resulting laminate is punched into a any shape, and at least one of the substrate and the covering member or a portion of the at least one has an air-permeability. Therefore, the heat-generating composition has an excellent heat-generating characteristic such that it can be brought into contact with air to generate a heat immediately. The sherbet-like heat-generating composition is distributed uniformly and fixed within a bag, whereby the movement and offsetting of the heat-generating composition can be prevented. As a result, an excessive exothermic reaction of the heat-generating composition can be avoided to the utmost to prevent a low-temperature burn of a human body, and a heater according to the present invention capable of being used safely can be produced.

(15) In the fifth process according to the present invention, a heater is sealed by a non-permeable film, thereby providing an effect that the heater having a ultra-thin structure and an excellent heat-generating performance can be preserved for a long period, while suppressing the deterioration thereof.

(16) In each of the first to fifth processes according to the present invention, if a film-shaped or sheet-shaped water-absorbing material, especially, a paper having a high water-absorbability is applied to one surface or opposite surfaces of the sherbet-like heat-generating composition according to the present invention, a portion of water in the sherbet-like heat-generating composition according to the present invention can be absorbed into the paper, and the heat-generating composition according to the present invention can be fixed further firmly to the paper.

(17) A non-woven fabric made using a highly water-absorbable fiber is used as a support for the heat-generating composition. Thus, it is possible to produce a sheet-shaped heater exhibiting a high heat-generating temperature and having an excellent heat-generating performance such as a longer heat-generating duration, a thin structure and a softness. Therefore, the heater can be mounted in a fit state on any portion of a human body for the purpose of heating or warming an affected part, and a heat-generating effect can be maintained over a long time.

The above and other objects, features and advantages of the invention will become apparent from the following description of the preferred embodiment taken in conjunction with the accompanying drawings.

### BRIEF DESCRIPTION OF THE DRAWINGS

FIG. 1 is a plane view of a filter paper for measuring a water mobility value in a heat-generating composition according to the present invention;

FIG. 2 is a view showing a method for measuring the water mobility value in the heat-generating composition according to the present invention;

FIG. 3 is a sectional view taken in FIG. 2;

FIG. 4 is a sectional view taken in FIG. 2;

FIG. 5 is a plane view of the filter paper after the measurement of the water mobility value in the present invention;

FIG. 6 is a plane view of one embodiment of a heater according to the present invention;

FIG. 7 is a sectional view taken along a line VII-VII in FIG. 6;

FIG. 8 is a sectional view of another embodiment of a heater according to the present invention;

FIG. 9 is a sectional view of a further embodiment of a heater according to the present invention;

FIG. 10 is a diagram of heat-generating characteristics of the heater according to the embodiment of the present invention and a heater of a comparative example;

FIG. 11 is a plane view of a yet further embodiment of a heater according to the present invention;

FIG. 12 is a sectional view of a yet further embodiment of a heater according to the present invention;

FIG. 13 is a sectional view of a yet further embodiment of a heater according to the present invention; and

FIG. 14 is a diagrammatic illustration showing a force-through die molding according to the present invention.

### DETAILED DESCRIPTION OF THE INVENTION

In a sherbet-like heat-generating composition according to the present invention, a surplus amount of free water in a heater can be decreased, and a heat-generating performance can be enhanced remarkably. Moreover, it is possible to prevent the generation of a dust during production of the heater, and to employ a force-through die molding process, a force-in die molding process, a printing process such as a screen printing, a coating printing, and a transferring process. Therefore, the uniform distribution of the heat-generating composition can be achieved and moreover, the thickness and the thickness-distribution accuracy of the heat-generating composition are higher, leading to an enhancement in quality of the product, and thus, a ultra-thin heater can be produced simply and at a high speed. Further, the heat-generating composition can be fixed in a bag-shaped material in an equally distributed state by subjecting the heat-generating composition to a force-through die molding or a force-in die molding between a water-absorbable substrate and a water-absorbable covering member or between water-absorbable layers formed on the substrate or the covering member, or on a wrapping member having a water-absorbability. As a result, it is possible to ensure the heat-generating performance and to prevent the heat-generating composition from moving and offsetting. In addition, it is also possible to prevent the movement and the offsetting by covering at least a portion of the heat-generating composition in a net shape with a polymer in a melt-blow process. Therefore, even if the heat-generating composition is accommodated in a bag made of a material having a large air-permeability, the movement and offsetting of the heat-generating composition in the bag are more difficult to occur.

Alternatively, if the heat-generating composition according to the present invention is laminated on a water-permeable substrate, and some of surplus water is discharged by depressurization, the same effect as that described above is provided.

The flowability such as a viscosity of the heat-generating composition according to the present invention may be of any degree, if it is within such a range that the heat-generating composition can be molded, and a water-discharging property and a heat-generating property can be ensured.

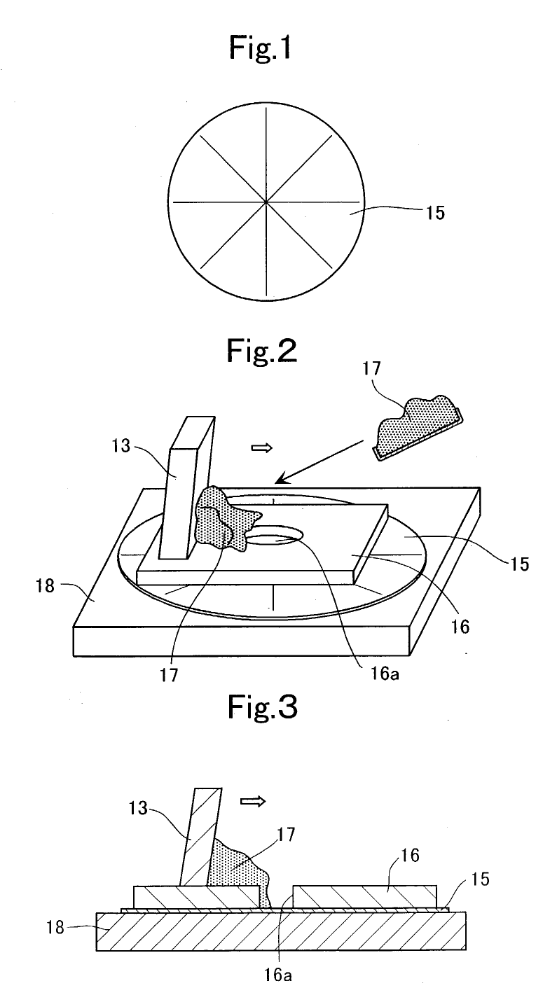

The water mobility value of the heat-generating composition according to the present invention means a value representing a surplus amount of water capable of being moved out of the heat-generating composition. The water mobility value will be described below with reference to FIGS. 1 to 5.

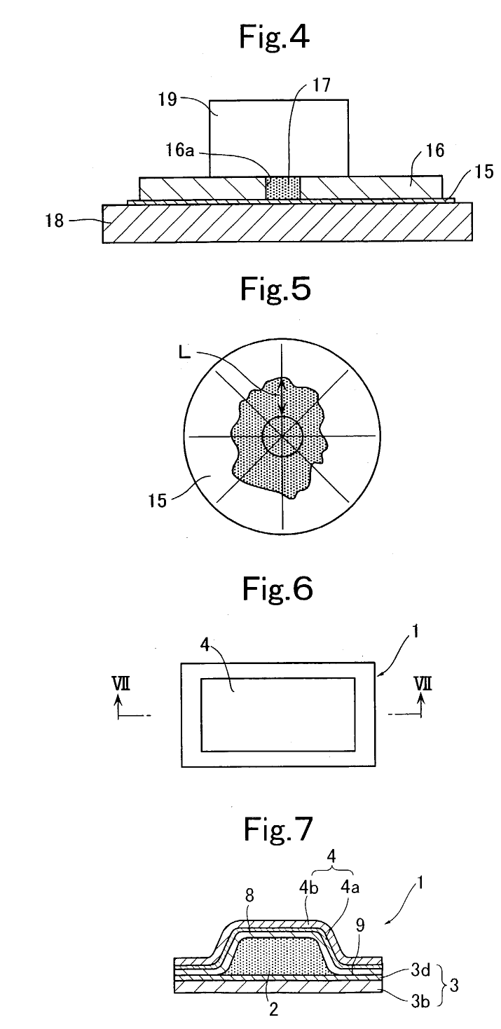

A No.2 filter paper 15 having eight lines drawn thereon radially at distances of 45° from the center as shown in FIG. 1 is placed on a stainless plate 18, and a die plate 16 provided with a cylindrical hole 16a having an inside diameter of 10 mm and a height of 4 mm is placed at the center of the filter paper 15. A sample 17 is placed on the die plate 16 at a location closer to the cylindrical hole 16a, and a forcing-in plate 13 is moved on the die plate 16 to force the sample 17 into the cylindrical hole 16a (a force-in die molding). Further, the cylindrical hole 16a having the sample 17 contained therein and the periphery thereof are covered with a windshield 19 and maintained for 5 minutes, as shown in FIG. 4. Thereafter, the filter paper 15 is removed, and water-permeated loci are read along the lines drawn radially as a distance L in mm unit from a circumference which is an edge of the cylindrical hole 16a to a tip end of the permeation of water. Namely, the distances L on the lines are read to provide a total of eight values (FIG. 5) Each of the read eight values (a, b, c, d, e, f, g and h) is called a measured water value.

The eight measured water values are mathematically averaged, and a resulting average value is determined as a water value (mm) of the sample.

An amount of water for measuring a true water value (mm) is defined as an amount of water incorporated in the heat-generating composition corresponding to the weight of the heat-generating composition having the inside diameter of 10 mm and the height of 4 mm. The similar measurement and calculation are conducted in a case of only water corresponding to such amount of water to provide a true water value (mm). A value provided by dividing the water value by the true water value and by multiplying a resulting value by 100 is defined as a water mobility value.

Namely, water mobility value={water value (mm)/true water value (mm)}×100.

It should be noted that the water mobility value is a value upon the lamination conducted by the force-in die molding or the like.

The water mobility value (0 to 100) of the sherbet-like heat-generating composition is preferably in a range of 7 to 50, more preferably in a range of 8 to 45, further preferably in a range of 9 to 40. If the water mobility value is smaller than 7, when the composition is passed through the die for lamination on the substrate, the flowability is poor and thus, the lamination is failed. If the water mobility value exceeds 50, the composition overflows from the shape of the die, whereby the shape of the composition cannot be maintained.

The heat-generating composition according to the present invention, because it is in the sherbet state, can be molded by the force-through die molding or the force-in die molding, printed using a known printing technique such as a thickly coating printing, an offset printing, a screen printing, a spraying, or transferred and laminated extremely easily by a coating using a head coater, a roller, an applicator or the like, and in this manner, a ultra thin heater can be produced at a high speed. Moreover, the heat-generating composition according to the present invention can be distributed uniformly in the bag material. Especially, the force-through die molding process permitting the characteristic of the sherbet-like heat-generating composition to be kept effectively is preferred.

The heat-generating composition according to the present invention is prepared in the sherbet state and hence, when the composition is laminated, for example, by a high-speed printing or coating, it can be laminated, for example, at a substrate feed speed in a range of about 100 to 200 m/min, for example, with a thickness in a range of from a large value to a smaller value on the order of 0.02 to 3.0 mm and moreover with a uniform thickness in at least one predetermined region.

If the heat-generating composition according to the present invention is laminated on the substrate, and a covering member in the form of a roll film or a roll sheet is put over the resulting laminate, the heater can be produced.

Because the heat-generating composition is in the sherbet state, the surplus water which is free water serves as a barrier layer and hence, the amount of air supplied is reduced to substantially stop an exothermic reaction. However, the water discharging property is good and hence, water is evaporated from the surface by leaving the composition in the air for a short time to start the exothermic reaction, which can be continued as it is.

Namely, the above-described various disadvantages are arisen in the conventional powdery heat-generating composition or the conventional creamy heat-generating composition, but if a heat-generating composition free from a viscosity-increasing agent such as a thickener is prepared in a sherbet state as in the present invention, it is easy to conduct the force-through die molding, the force-in die molding and the transferring and lamination by the screen printing or the coating, and thus, a ultra-thin heater can be produced. After the molding, the free water which is the surplus water can be discharged out of the heat-generating composition and hence, a high heat-generating performance is maintained.

If some of the free water which is the surplus water is discharged out of the heat-generating composition by depressurization or the like, or absorbed into a bag-shaped material such as the substrate and/or the covering member, the barrier layer disappears, and the heat-generating composition is made porous by absorption of water into the wrapping member, leading to an enhanced contact with air. Thus, the heater exhibits a good heat-generating characteristic. Moreover, because the heat-generating composition is in the sherbet state, it does not have a consistency as does a creamy or paste composition and hence, the amount of water can be decreased simply in a short time down to a level required for the reaction. In addition, unlike an ink-like, creamy or paste heat-generating composition containing a thickener, a binder and/or the like, there is no adverse influence to the heat-generating characteristic due to the thickener or the binder in the heat-generating composition according to the present invention.

A heat-generating substance, a carbon component, an oxidation promoter and water used in the present invention are particularly not limited, if they are used in a usual body warmer.

Examples of components added for the purpose of improving a water-permeability, a flowability, a dispersibility, a die-release property, a shape retention, an adherence to the substrate and the like without provision of a consistency are an inorganic water-retaining agent, an organic water-retaining agent, a pH adjuster, a surfactant, an antifoaming agent, a hydrophobic polymer compound, bentonite, a pyroelectric material, an antioxidant, an aggregate and a heat-generating assistant. Such components are not limited, if they are used in a usual body warmer. In some cases, such a small amount of a water-absorbable polymer or binder to provide no consistency may be incorporated, and the entire composition may be prepared in a sherbet state.

The amount of each of the components in the heat-generating composition according to the present invention may be of any value, if the moldability and the heat-generating characteristic can be maintained, but in usual, the heat-generating composition comprises 1 to 40 parts by weight of a carbon component, 0.2 to 30 parts by weight of an oxidation promoter and 2 to 100 parts by weight of water based on 100 parts by weight of a heat-generating substance, and preferably, comprises 1.5 to 30 parts by weight of a carbon component, 0.7 to 10 parts by weight of an oxidation promoter, and 3 to 85 parts by weight of water based on 100 parts by weight of an iron powder. Further, the heat-generating composition can be prepared in the sherbet state as a whole by setting the water mobility value in a range of 7 to 50.

Further, the heat-generating composition may contain another component incorporated therein in an amount in such a range that the sherbet state is maintained. Such other component is at least one component selected from the group consisting of 0.1 to 10 parts by weight of an inorganic or organic water-retaining agent, 0.01 to 10 parts by weight of a pH adjuster, 0.01 to 10 parts by weight of a surfactant for enhancing the dispersibility, 0.01 to 10 parts by weight of an antifoaming agent, and 0.01 to 10 parts by weight of a hydrophobic polymer compound.

To mix these components, any mixing process may be used, if it can produce a sherbet-like heat-generating composition, but one example of the mixing process is to mix only the solid components homogeneously and then incorporate water or an aqueous solution or dispersion of a metal chloride, or to add an appropriate amount of water to the solid components within the above-described range of water content and then mix all the components homogeneously.

In some cases, a thickener, a binder and/or a coagulation assistant may be incorporated as desired in an amount in a range of, preferably, 0.01 to 1.0 parts by weight, more preferably, 0.01 to 0.09 parts by weight such that a consistency is not provided, thereby providing a heat-generating composition in a sherbet state. If the amount of coagulation assistant, thickener and/or binder added exceeds 1.0 parts by weight, a consistency is provided to make it difficult to discharge the free water, and the heat-generating property of the heat-generating substance is detracted due to the adhesion (deposition) of the thickener of the like to the heat-generating substance to adversely influence the exothermic reaction.

A water-absorbable polymer may be likewise added in an amount in such a range that a consistency is not increased. The term “such a range that a consistency is not increased” means that a difference between the Brookfield viscosity S of the heat-generating composition comprising the heat-generating substance, the carbon component, the oxidation promoter and water and the Brookfield viscosity T of the heat-generating composition comprising the above-described components and an additive such as a water-absorbable polymer and/or the like, i.e., a T-S valve is equal to or smaller than 20,000 cps (including 0 (zero) and minus values).

The Brookfield viscosity assumes a value measured by a Brookfield viscometer in a stable state using a #7 rotor is placed into a sample and rotated at 2 rpm for 3 minutes.

The full scale of the Brookfield viscometer using a #7 rotor at 2 rpm is 2,000,000 cps.

In addition, when the sherbet-like heat-generating composition is interposed between the substrate and the covering member, at least one component selected from an iron powder, a carbon component, a water-absorbing agent, a water-absorbable polymer, a binder, a thickener and a coagulation assistant may be laminated or scattered onto one or both of sides of the heat-generation composition according to the present invention, so that the rinsing of the heat-generating temperature in the service of the heat-generating composition may be hastened, or the temperature characteristic in the service of the heat-generating composition may be changed. In this case, the amount of one component laminated or scattered is particularly not limited, if it does not detract the temperature characteristic, but in general, it is preferable that the amount is in arrange of 1 to 300 gr/m². One example of the water-absorbing agent is pulp, cotton, papers, a volcanic ash material and a water-retaining agent.

Here, a mixture comprising an iron powder coated with a carbon component, or an iron powder (A) and a carbon component (B) and water added in an amount of 5% or less by weight based on a total amount of (A) and (B) may be used.

The heat-generating substance may be of any type, if it reacts with oxygen to generate a heat, and in general, a metal is used. For example, a powder of iron, zinc, aluminum or magnesium, or a powder of an alloy containing one or more of these metals, or a mixed-metal powder including tow or more of these metals is used. It is preferable that among them, a powder of iron most excellent from the overall viewpoint of stability, handleability, cost, self-stability and stability is used. Examples of iron powders, which may be used, are a cast iron powder, a atomized iron powder, an electrolyzed iron powder, a reduced iron powder and the like. Further, the iron powder containing carbon is useful.

Especially, an iron powder having a surface partially coated with 0.3 to 3.0% by weight of a conductive carbonaceous substance is useful. Illustrative of the conductive carbonaceous substance are carbon black, activated carbon and the like, and illustrative of the iron powder are a reduced iron powder, an atomized iron powder and a spongy iron powder. Especially, a case where the conductive carbonaceous substance is activated carbon and the iron powder is a reduced iron powder, is useful for a chemical body warmer.

In this case, to coat the iron powder with the carbon component, a cathode formation of a thin-film can be achieved by a coating treatment for 30 minutes to 3 hours in a ball mill, a conical blender or the like. One example of the coating process is to knead a 0.1 to 10 parts by weight of the carbon component with 100 parts by weight of the iron powder for 10 to 80 minutes at a rotational speed of 500 to 1,500 rpm, using a press-type mixer (made under a name of AM-15F by Hosokawa Micron, Co.) Alternatively, an iron powder, a carbon component and water or brine may be mixed together and extruded by a mixable and extrudable screw or the like; another component such as a water-retaining agent may be then added and mixed, and the resulting mixture may be extruded to produce a heat-generating agent.

Illustrative of the carbon component are carbon black, graphite or activated carbon. Activated carbon made from a shell of coconut, a wood piece, charcoal, coal, bone black or the like is useful, but activated carbon made from another starting material such as a product made by an animal, a natural gas, fat, an oil and a resin is also useful for the heat-generating composition according to the present invention. The type of activated carbon used is not limited, but activated carbon having an excellent adsorbing/retaining ability (preferably having a iodine-adsorbing performance in a range of 800 to 1,200 g/g and a methylene blue-decoloring power in a range of 100 to 300 mg/g) is preferred. A mixture of the above-described activated carbons may be used.

The oxidation promoter maybe of any type, if it can promote the oxidation of the heat-generating substance. Examples of the oxidation promoter are metal halides such as sodium chloride, potassium chloride, magnesium chloride, calcium chloride, ferrous chloride, ferric chloride, copper(I) chloride, manganese chloride and copper(II) chloride; metal sulfates such as potassium sulfate, sodium sulfate, magnesium sulfate, calcium sulfate, copper sulfate, ferrous sulfate, ferric sulfate and manganese sulfate; nitrates such as sodium nitrate, potassium nitrate; and acetates such as sodium acetate and the like. Any of carbonates and other salts of the above-described metals or other metals may be also used. These salts may be used alone or in combination.

The water may be one from a suitable source. The purity, the type and the like of the water are not limited.

Typical of the above-described volcanic ash material (volcanic gravel) are terra-balloon containing silicon, aluminum, oxygen and the like as main ingredients (which is a very fine hollow closed-cell foam made from the rapid heating of a volcanic glass), shirasu balloon, taisetsu balloon, Kanuma clay, Akadama clay, Fiji sand, floatstone, or calcined and/or pulverized products of them. These materials are excellent in water-absorbability and water-retaining property, leading to an enhancement in heat-generating characteristic.

Typical of the water-retaining agent are activated clay, hydrated magnesium silicate-based clay minerals such as, zeolite, perlite, cristobalite, vermiculite, silica-based porous materials, a coralline material,silica powder,calcium silicate, quartzite, diatomaceous earth, alumina, siliceous materials such as a mica powder or clay, a silica powder, calcium silicate and the like, magnesia siliceous materials such as talc, a silica powder, aubrite, wood powder, pulp powder, activated carbon, sawdust, a cotton cloth having a large number of downs, short fiber of cotton, paper scraps, vegetable materials, and other porous materials having a large capillary function and a hydrophilic nature. Calcined and/or pulverized products of the above-described materials may be used in order to increase the water-retaining power and to increase the shape-maintaining power and the like.

Particular examples of the hydrated magnesium silicate-based clay minerals (which will be referred to as clay minerals hereinafter), typical of which is sepiolite, include sepiolite essentially comprising hydrated magnesium silicate, white tile, rafurinaito, farukondoaito, palygorskite essentially comprising hydrated magnesium aluminum silicate, and the like. They may be used alone or in the form of a mixture. What correspond to them are minerals commonly called mountain cork, mountain wood, mountain leather, sepiolite, attapulgite and the like.

Any material can be used as the inorganic or organic water-retaining agent, if it cannot provide a consistency significantly and can retain water. Especially, an inorganic very fine hollow foam is useful.

The hydrophobic polymer compound may be any polymer compound, if it has an angle of contact with water equal to or larger than 40°, preferably, 50°, more preferably, 60° in order to improve the draining of the composition. The shape of the hydrophobic polymer compound is not limited, and for example, may be powdery, particulate, granular, tablet-shaped and the like, but the powdery, granular and particulate shapes are preferred.

Typical of the hydrophobic polymer compound are a polyolefin such as polyethylene, polypropylene and the like, a polyester such as polyterephthalic ethylene, a polyamide such as nylon, polyvinylidene, polyvinyl chloride, polystyrene, a fluorine resin such as polytetrafluoroethylene and polytrifluoroethylene, and an acrylic resin such as polymethyl methacrylate, polymethyl acrylate.

The pH adjuster may be the weak acid salt and hydroxide of an alkali metal, or the weak acid salt and hydroxide of an alkali earth metal, typical of which are Na₂CO₃, NaHCO₃, Na₃PO₄, Na₂HPO₄, Na₅P₃O₁₀, NaOH, KOH, CaCO₃, Ca(OH)₂, Mg(OH)₂, Ba(OH)₂, Ca₃(PO₄)₂, Ca(H₂PO₄)₂ and the like.

The hydrogen inhibitor maybe any substance, if it inhibits the generation of hydrogen, and examples of the hydrogen inhibitor are one or two or more of a metal sulfide such as calcium sulfide, an oxidant, an alkaline substance, sulfur, antimony, selenium, phosphorus and tellurium, or the pH adjuster. If the hydrogen inhibitor is mixed previously in a metal powder which is a heat-generating agent, the amount of hydrogen inhibitor can be decreased, leading to an increased effect.

Examples of the oxidizing agent of hydrogen inhibitor are a nitrate, a nitrite, an oxide, a peroxide, an oxyacid halide, permanganate, achromate and the like, typical of which are NaNO₃, KNO₃, NaNO₂, KNO₂, CuO, MnO₂, H₂O₂, NaClO, NaClO₃, NaClO₄, NaMnO₄, KMnO₄, Na₂CrO₄, K₂ClO₄ and the like.

Examples of the alkaline substance are a silicate, borate, a bibasic phosphate, a tribasic phosphate, a sulfite, a thiosulfate, a carbonate, a biocarbonate and the like, typical of which are Na₂SiO₃, Na₄SiO₄, NaBO₄, Na₂BO₇, KBO₂, Na₂HPO₄, Na₂SO₃, K₂SO₃, Na₂S₂O₃, Na₂CO₃, NaHCO₃, K₂S₂O₃, CaS₂O₃, Na₂P₃O₁₀ and the like.

If the hydrogen inhibitors are used in combination, a combination of an alkali salt of weak acid and an alkali salt of weak acid such as combinations of Na₂SO₃ and Na₂SiO₃, Na₂SO₃ and Na₂SiO₃, Na₂SO₃and Na₂B₄O₇, Na₂B₄O₇ and Na₃PO₃, Na₂CO₃ Na₂SO₃, and a combination of an oxidizing agent and an alkali salt of weak acid such as combinations of Na₃PO₄ and Na₂SO₃, Na₅P₃O₁₀ and Na₂SO₃, NaNO₂ and Na₂SiO₃, NaNO₂ and Na₂HPO₄, NaNO₂ and Na₂SO₃, NaNO₂ and Na₂S₃O₃, NaNO₃ and Na₂SiO₃, NaNO₂ and Na₂S₂O₃, NaNO₃ and Na₂Si₂O₃, NaNO₃ and Na₂HPO₄, NaNO₃ and Na₂SO₃, NaNO₃ and Na₂S₂O₃, MnO₂ and NaSiO₃, MnO₂ and Na₂HPO₄, MnO₂ and Na₂S₂O₃, NaClO and Na₂SiO₃, NaCl and Na₂HPO₄, NaClO and Na₂SO₃, KMnO₄ and Na₂SiO₃, KMnO₄ and Na₂HPO₄, KMnO₄ and Na₂HPO₄, S and Na₂SO₃, S and Na₂S₂O₃ and the like.

The total amount of hydrogen inhibitors used is preferably in a range of 0.01 to 12.0% by weight, more preferably in a range of 0.05 to 8% by weight, further preferably in a range of 0.5 to 2.0% by weight. If the total amount is lower than 0.01% by weight, an effect of inhibiting the generation of hydrogen is poor. If the total amount exceeds 12.0% by weight, an effect of inhibiting the generation of hydrogen is provided, but a heat-generating temperature is dropped and hence, the total amount exceeding 12.0% by weight is not suitable.

It is preferable from the viewpoints of the workability and the uniformity of mixing that the hydrogen inhibitor is added in the form of an aqueous solution, but even if the hydrogen inhibitor is added in the solid form separately from water, the hydrogen-inhibiting effect is little different from that provided when the hydrogen inhibitor is added in the form of the aqueous solution.

When the oxidizing agent such as a peroxide, an oxyacid halide and the like is added to the heat-generating agent, a catalytic cracking is caused, and hence, it is preferable that an aqueous solution of the oxidizing agent is soaked previously into the iron powder, and in this case, an increased hydrogen-inhibiting effect is provided.

When a nitrite or nitrate is added to the heat-generating agent, an ammonia gas is generated. Therefore, it is preferable, as compared with the direction addition of the nitrite or nitrate, that the iron powder is impregnated previously with an aqueous solution of a nitrite or nitrate, and the resulting material is then neutralized. In this case, an ammonia smell can be removed easily.

The surfactant includes anionic, cationic, nonionic and ampho-ion surfactants. However, if the surfactant is used, the nonionic surfactant is preferred.

Ethylene oxide, ethylene glycol, propylene oxide, propylene glycol and a polymer containing any of them are likewise useful as an additive.

Typical of the nonionic surfactant are polyoxyethylene alkyl ether, an ethyl oxide adduct of castor oil, an ethylene oxide adduct of an alkyl phenol such as an ethylene oxide adduct of nonyl phenol or octyl phenol, an ethylene oxide adduct of a medium alcohol or a higher alcohol, mono-, di-, tri- and tetra-esters of a polyhydric alcohol fatty acid, an ether or ester of polyoxyethylene polyol fatty acid, a phosphate ester of a higher alcohol and the like.

Particular examples of the other surfactants are a surfactant such as sodium dodecylsulfate, sodium dodecylbenzene sulfonate, sodium caproate, sodium caprate, sodium alkyl-naphthalene sulfonate, sodium laurate, sodium oleate or a phosphate, a surfactant such as di-sodiummonoester of a higher alcohol phosphoric acid, di-sodium di-ester of a higher alcohol phosphoric acid and the like, and a surfactant such as a fatty acid and the metal salt thereof such as oleic acid, linoleic acid, linolenic acid, lauric acid, palmitic acid, myristic acid, stearic acid and the like, the salt of polycarboxylic acid having a low polymerization degree, e.g., sodium polyacrylate having a low polymerization degree, polybutylacrylate having a low polymerization degree, sodium polymethacrylate having a low polymerization degree, and solfonated polystyrene and the like.

The surfactants maybe used alone or in the form of a mixture. A commercially available synthetic detergent containing any of these surfactants may be used.

The binder may be any of an inorganic agent, an organic agent, and a water-dispersed emulsion-type agent, but an agent having an affinity for water is preferred.

Typical of the binder or the thickener are bentonite, stearate, polyacrylate such as sodium polyacrylate, gelatin, polyethylene oxide, polyvinyl alcohol, polyvinyl pyrrolidone, gum arabic gum, tragacanth, locust bean gum, guar gum, an alginate such as sodium alginate, pectin, a carboxyvinyl polymer, dextrin, a urea-melamine resin, polyurethane, polyvinyl acetate, polyvinyl alcohol, polyvinyl acetal, a polyacrylate such as cyanoacrylate polymers, a heterocyclic compounds, a cellulose derivative, e.g., carboxymethyl cellulose, ethylacetate cellulose, hydroxypropyl cellulose, hydroxyethyl cellulose, methylcellulose, hydroxypropyl cellulose, ethylcellulose, starches such as dextrin, α-starch, a processed starch, corn starch, potato starch, polysaccharides, e.g., sodium alginate, chondrus crisps, agar, polyethylene glycol, xanthan, mannan, casein, alginic acid, albumin, an acryl sulfonate-based polymer substance, poly-N-vinylacetoamide and the like.

Typical of the water-dispersed emulsion are a polyacrylate emulsion, a polyvinyl acetate emulsion, a polybutadiene emulsion and the like.

Typical of the in organic binder are cements, e.g., Portland cement, magnesia cement, silicates, e.g., sodium silicate, potassium silicate, phosphates, e.g., zinc phosphate cement, aluminum phosphate, sulfates, e.g., gypsum and the like. An anticoagulant such as tri-calcium phosphate, sodium silicoaluminate, may be used.

Typical of the coagulation assistant are a corn sirup, a crystalline sorbitol sirup, an amorphous sorbitol sirup, and a mixture of them.

One example of the mixture is a mixture of two or more of the above-described syrups. Any of the syrups treated with a surfactant may be used, or any of the syrups may be combined with a surfactant to enhance the affinity.

Examples of the antifoaming agent, which may be used, are a usual pH adjuster such as sodium polyphosphate, and another pH adjuster used in this field.

The water-absorbable polymer may be any polymer substance, if it absorbs water and an aqueous solution of a metal chloride smoothly and in a large amount.

The water-absorbable polymer may be one of, or a mixture of two of an isobutylene-maleic anhydride copolymer, a polyvinyl alcohol-acrylate copolymer, a starch-acrylate graft polymer, a crosslinked product of polyacrylate, an acrylate-acrylicester copolymer, a polyacrylate-acrylamide copolymer, the hydrolyte of a crosslinked product of polyacrylonitrile, a starch/polyacrylonitrile copolymer, a crosslinked polyalkylene oxide, a saponified product of a vinyl ester/ethylenic unsaturated carboxylic acid copolymer, a self-crosslinked polyacrylate, a reaction product of a polyvinyl alcohol-based polymer and a cyclic anhydride, a crosslinked polyacrylate, a crosslinked N-vinyl acetamide and the like. Any of these substances treated with a surfactant may be used, or any of these substances may be combined with a surfactant to enhance the affinity.

The water-absorbable polymer is particularly not limited, if it is capable of absorbing an amount of water two times its own weight for gelation, but a water-absorbable polymer provided with a crosslink to control the solubility in water is particularly preferred. Especially, a water-absorbable polymer having a water-absorption of 50 times or more is further preferred.

Examples of the pyroelectric material are tourmaline such as dravite, shale, elbaite and the like.

The aggregate may be of any type, if it is useful for rendering the heat-generating composition porous, but typical of the aggregate are activated clay, activated carbon, charcoal, bentonite, perlite, a silica/alumina powder, a silica/magnesia powder, a calcined magnesia, kaolin, pumice stone, zeolite, a magnesia powder, a precipitated alumina powder, activated alumina, calcium carbonate, silica gel, cristobalite, vermiculite, a silica-based porous material, a silicate such as calcium silicate, quartzite, diatomaceous earth, oxidized alumina, oxidized aluminum siliceous materials such as magnesia siliceous materials such as a mica powder and a clay, magnesia siliceous materials such as talc, a silica powder, organic and/or inorganic short fibers, a wood powder, a pulp powder, metasilicate, zirconium, ceramics, aubrite and the like.

Examples of the heat-generating assistant are a metal powder, a metal salt, a metal oxide and the like, typical of which are Cu, Sn, Ni, Cr, Mn, CuCl₂, FeCl₂, FeCl₃, CuSO₄, FeSO₄, CuO, MnO₂, MgO, CaO, manganese dioxide, copper(I) oxide, Fe₃O₄, a compound containing any of these elements, and a mixture of some of these elements.

Examples of the filler are, and broken pieces of natural cellulose including sawdust, cotton linter and cellulose, a synthetic fiber in a broken form including a polyester fiber, a foamed synthetic resin such as a foamed polyester and polyurethane, and an inorganic compound including a silica powder, porous silica gel, sodium sulfate, barium sulfate, iron oxide and alumina, and the like.

The foaming agent may be of any type, if it can generate a gas for foaming. The foaming agent includes a decomposition-type foaming agent comprising a single substance decomposed by heating to generate a gas, and a reaction-type foaming agent comprising two or more substances reacted with each other to generate a gas. The decomposition-type foaming agent is particularly not limited, but an inorganic decomposition-type foaming agent is suitably used. Typical of the inorganic decomposition-type foaming agent are sodium bicarbonate, ammonium carbonate, ammonium bicarbonate and the like.

The reaction-type foaming agent is particularly not limited, but typical of the reaction-type foaming agent suitably used are carbonates, bicarbonates, and combinations of light metals such as magnesium, zinc, aluminum and the like and acidic substances such as sulfamic acid, citric acid and the like.

Other examples are combinations of light metals such as magnesium, zinc, aluminum, and silicon and the like and basic substances such as caustic soda, caustic potash, calcium hydroxide, carbonate soda and the like. A further example is calcium carbide, which generates an acetylene gas in the presence of water.

Each of the reaction-type foaming agents causes the foaming, particularly even if it is not heated, but it can be the heated.

The water absorbent may be of any type, if it is capable of absorbing water, but examples of the water absorbent are a water-retaining agent, activated carbon, a binder, a water-absorbable polymer, a thickener, a coagulation assistant, a filler, an aggregate and the like such as those described above.

The carbon component in the sherbet-like heat-generating composition according to the present invention may be of any particle size, if it can be molded, but it is preferable that a carbon component having a particle size in a range of 150 μm (inclusive) to 600 μm (inclusive) is contained in a content in a range of 2% (inclusive) to 85% (inclusive).

The solid component other than the carbon component may be of any size, if it can be likewise molded, but it is preferable that at least 70% or more by weight of the solid component has an average size of 600 μm or less, and further, at least 50% by weight, preferably, 70% by weight, more preferably, 80% by weight, most preferably, 90% by weight of the solid component has an average size in a range of 200 μm (inclusive), perferebly 150 μm (inclusive). Thus, a sherbet-like heat-generating composition having a good drain ability and excellent information of a shape is formed.

If the content of the solid component having a size larger than 200 μm is higher than 50% by weight, the printability and the shape retention are detracted.

The polymer used as a reticulated polymer may be an oligomer or a higher polymer, and examples thereof are polymers of adhesive type and self-adhesive type, but the polymer may be of any of an emulsion type, a solvent type and a hot-melt type, if they have an ability to fix the composition by an adhesion or a self-adhesion. Typical of the polymer of self-adhesive type are a vinyl acetate-based self-adhesive, a polyvinyl alcohol-based self-adhesive, a polyvinyl acetal-based self-adhesive, a vinyl chloride-based self-adhesive, an acrylic self-adhesive, a polyamide-based self-adhesive, a polyethylene-based self-adhesive, a cellulose-based self-adhesive, a chloroprene (neoprene)-based self-adhesive, a nitrile rubber-based self-adhesive, a polysulfide-based self-adhesive, a butyl rubber-based self-adhesive, a silicone rubber-based self-adhesive, a styrene elastomer-based self-adhesive (e.g., SIS, SBS, SEBS (a hydrogenation of SBS), SIP (a hydrogenation of SIS), an acrylic elastomer essentially comprising an alkyl ester such as an acrylate and a methacrylate, an olefinic elastomer such as polyethylene, an extremely low-density polyethylene, polypropylene and an ethylene/vinyl acetate copolymer, a urethane-based elastomer and the like.

These substances may be used along or in the form of a mixture. In addition, these substances may be used in the form of an aqueous emulsion.

It should be noted that the tack and strength can be adjusted by adding an olefinic elastomer to a styrene-based elastomer. In the preparation of a lowly tacky substance, an additive or additives such as a tackifier, a softening agent, an antioxidant may be incorporated as required.

Examples of the adhesive of the hot-melt type are a polyolefine such as polyethylene, a usual hot-melt adhesive such as a polyester, a polyamide and the like, and an adhesive containing a bonding component such as a styrene/butadiene copolymer, an acrylic acid ester copolymer, a vinyl acetate/ethyelene/olefine terpolymer, a petroleum resin, a cold glue and the like.

A heater according to the present invention will be described below in detail. The heater according to the present invention has a feature that it is formed in the following structures: A sherbet-like heat-generating composition of the above-described type is laminated to and sealed within an accommodating bag having an air-permeability at least partially, so that a portion of water in the sherbet-like heat-generating composition is discharged out of the system or absorbed into the accommodating bag, or a sherbet-like heat-generating composition of the above-described type is laminated to an underlay member or interposed between underlay members and further sealed into a wrapping member, which is comprised of a substrate and a covering member. Alternatively, a sherbet-like heat-generating composition according to the present invention is laminated to and sealed within a sheet-shaped wrapping member, so that a portion of water in the heat-generating composition is absorbed into the sheet-shaped wrapping member, a substrate and/or covering member or a underlay member, or so that water is volatilized in a leaving manner, or discharged by a suction or by a centrifugal separation during and/or after the lamination, or a water-absorbable material such as a water-retaining agent is placed in a contact manner on the heat-generating composition by lamination or scattering, or a portion of water is discharged out of the heat-generating composition by a combination of the above-described manners, thereby enabling the generation of a heat.

In the heater according to the present invention, it is preferable that the accommodating material or the wrapping member comprises a substrate in the form of a film, a sheet or a non-woven fabric. It is preferable that at least one of the substrate and the covering member has an air-permeability, or each of the substrate and the covering member has an air-permeability partially. Further, a substrate and/or a covering member having a water-absorbability are preferred.

A starting material for the substrate, the covering member or the underlay member used in the heater according to the present invention includes those comprising a single layer and a plurality of layers laminated one on another in a thickness-wise direction. In this case, the lamination means that the layers are bonded together entirely or partially by a heat setting, an adhesion, a sticking, a lamination and the like, or merely superposed one on another and bonded together locally, e.g., at their peripheral edges or central portions by a heat sealing, by use of a hot-melt adhesive or a self-adhesive and the like.

To produce the heater, a heat-generating composition having a film thickness according to the present invention is laminated to one predetermined region on the bas material in the form of the film, the sheet or the non-woven fabric, and the covering member in the form of the film, the sheet or the non-woven fabric is then put on the heat-generating composition to cover the latter. The substrate and the covering member are adhered to each other with the heat-generating composition interposed therebetween. In order to further enhance the quality and the reliability, it is of course preferable that the substrate and the covering member are bonded to each other around the heat-generating composition in a sealed manner by a sticking, a thermal adhesion or a thermal fusion-bonding. At this time, the pressing and/or the heating may be used as desired.

A polymer may be put in a net-shape on the heat-generating composition by a melt-blow, an application, a spraying or a coating to more ensure the fixing of the heat-generating composition and the substrate. Examples of the polymer are preferably a thermoplastic polymer compound, an emulsion type self-adhesive, a hot-melt type self-adhesive and the like.

Examples of the substrate, the covering member, the underlay member and the like are a foamed or non-foamed film or sheet made of a polymer material or a non-woven fabric. The laminated-type substrate, covering member or underlay member can be formed from a film, a sheet or a non-woven fabric, each having an air-permeability partially. The film, the sheet or the non-woven fabric each having the air-permeability partially can be produced using a foamed or non-foamed film or sheet, papers, a non-woven fabric or woven fabric made of a synthetic fiber or a natural fiber, or a porous film or sheet, a cloth, various synthetic resin films, and a composite sheet. The cloth may be a woven cloth, a knitted cloth or a non-woven cloth. A fiber for forming the cloth may be a regenerated fiber made using a natural material such as a natural fiber and a viscous fiber, a semi-synthetic fiber, a synthetic fiber, and a mixture of two of them.

When the film, the sheet or the non-woven fabric each having the air-permeability partially is produced using the synthetic resin film, for example, a film made of a polyethylene, a polypropylene, a nylon, a polyester, a polyvinyl chloride and the like may be perforated using a needle or a laser to have an air-permeability. These may be used a lone or in combination, but what is preferred from an aspect of a covering workability is a covering member or the like in which a fiber or a film having a lower melting point is disposed on a side contacting with a support and a fiber or a film which is non-meltable or has a higher melting point is disposed on the other side. Especially, a film, a sheet, a non-woven fabric and the like having a water-absorbability are useful.

Examples of the polymer, which is a material for forming the substrate, the covering member or the underlay member, are a polymer material such as a polyethylene, a polypropylene, a polyester, polyvinyl chloride, polyvinylidene chloride, a polystyrene, an ethylene/vinyl acetate copolymer or the saponified product thereof, a polycarbonate, an aromatic or aliphatic polyamide, a polysulfone, a polyvinyl alcohol, a polyacrylonitrile, a vinyl chloride/vinylidene chloride-based resin, a polyimide, a rubber hydrochloride, a polyphenylene oxide, a polyphenylene sulfide, a polyamide-imide, an epoxy resin, a polyamino-bis-maleimide, a polyacetal, a polyether ether ketone, a polyether sulfone, a polyarylate, a polyoxybezyl and the like, a natural material such as a paper, a pulp, a fiber, a cotton and the like, and a combination of them. Using any of these materials, a woven fabric, a fabric cloth, a non-woven fabric, a film, a sheet, a foamed sheet may be formed. A stretchable material having an adhesive provided thereon and a non-stretchable or substantially non-stretchable material stretched bi-axially are also included in a non-stretchable substrate. These can be used alone or in a laminate of two or more materials.

The stretchable material is particularly not limited, if it is stretchable. Examples of the stretchable material are a textile, a film, a spandex thread, a thread, a string, a flat plate, a slit film, a foam, a non-woven fabric, and a composite stretchable material made by laminating some of them on one another or on another non-stretchable material. The stretchable material also includes a material made to have a stretching property as a whole by entangling non-stretchable long fibers or continuous filaments at random, and adhering or fusion-bonding them at random. A nylon thread or the like may be wound around a stretchable thread such as a urethane thread to produce a protected stretchable thread.

Among the elastomers, a thermoplastic elastomer is preferred, because it has a thermal fusion-bond property, and it is very easy to produce a laminate comprising such thermoplastic elastomer and a non-woven fabric. If a material having no thermal fusion-bond property is used, a thermal fusion-bond property may be provided to this material by mixing a thermoplastic resin to such material, or such material may be adhered using an adhesive (including a self-adhesive) of a hot-melt type and the like. Further, when the stretchable material is non-permeable to air, a perforating means such a thermal-pin means, an embossing means and the like can be used to make pores, thereby providing an air-permeability together with a stretching property and an expanding property. In short, any of a simple material and a composite material made by a combination of stretchable materials with each other or a stretchable material and a non-stretchable material with each other may be used, if they are stretchable.

Particular examples of the synthetic rubber are a butadiene rubber, a 1,2-polybutadien rubber, an isoprene rubber, a styrene/butadiene rubber, a styrene/butadiene/styrene terpolymer, a butyl rubber, an acrylonitrile/butadiene rubber, a chloroprene rubber, an isobutylene/isoprene rubber, a polyalkylene sulfide, a silicone rubber, a poly(chloro-trifluoroethylene), a vinylidene fluoride/propylene hexafluoride copolymer, a urethane rubber, a propylene oxide rubber, an epichlorohydrin rubber, an acrylic ester/acrylonitrile copolymer, an acrylic ester-2-chloroethylevinyl ether copolymer and the like.

Particular examples of the thermoplastic elastomer are an olefinic elastomer, a urethane-based elastomer, an ester-based elastomer, a styrene-based elastomer, an amide-based elastomer, a vinyl chloride-based elastomer, a syndiotacticpoly(1,2-butadiene), a poly(trans-1,4-isoprene), a silicone-based elastomer and the like.

Examples of the olefinic elastomer are an ethylene/propylene copolymer, an ethylene/propylene/diene terpolymer, a chloro-sulfonated polyethylene, a chlorinated polyethylene, an ethylene/vinyl acetate copolymer and the like. Among others, a cyclopentadienyl complex, i.e., an ethylene-α-olefin formed using a metallocene catalyst is particularly preferred. Particularly preferable as an x-olefin are 1-hexene, 1-octene, 1-heptene, 4-methylpentene-1 and the like.

One example of the urethane-based elastomer is a urethane-based elastomer comprising a block having a urethane linkage, and a block having a polycarbonate-based polyol, an ether-based polyol, a polyether and polyester-based polyol, or a caprolactam-based polyester.

Especially, a polyurethane film formed from any of them has a feature that it is non-porous and has both of a permeability and a stretching property.

An example of the ester-based elastomer is an ester-based elastomer comprising a block having an aromatic polyester, a block having an aliphatic polyester or an aliphatic polyether.

Examples of a stretchable shape-memory polymer are polyisoprene-based and styrene/butadiene-based copolymers, polyurethane-based and polymer alloy-based polymers, and the like.

The thickness of each of the substrate and the covering member is varied depending on the application, but is particularly not limited. Specifically, when the heater is used for warming a foot, the thickness is preferably in a range of 10 to 5,000 μm. When the heater is used in a directly adhered state on a human body, the thickness is preferably in a range of 10 to 500 μm, more preferably, in a range of 12 to 250 μm. When the heater is used for a common application, the thickness is preferably in a range of 10 to 2,500 μm, more preferably, in a range of 12 to 1,000 μm.

The natural fiber includes a vegetable fiber such as cotton, flax, pulp, rayon and the like, and an animal fiber such as silk, wool and the like.

The stretchable and non-stretchable material may be transparent, opaque, colored or non-colored.

A composite stretchable material, which is a material having a stretching property as a whole and made by combining the above-described stretchable material with a material different from such stretchable material in respect of any of the form, the nature and the type, may be used as the stretchable material,

Examples of the non-woven fabric, which may be used, are a single non-woven fabric of a mono-component fiber or a bi-component fiber, a composite non-woven fabric of these fibers, or a laminated-type non-woven fabric formed of any of these fibers and having a laminated layer made of a different fiber, the mono-component fiber or a bi-component fiber being generally made of a material such as rayon, nylon, a polyester, an acrylic polymer, a polypropylene, a polyethylene, a urethane polymer, a cupro-ammonium rayon, cotton, a cellulose, pulp and the like. A dry non-woven fabric, a wet non-woven fabric, a spun bond, a spun lace and the like may be also used. Further, a non-woven fabric of a sheath-core type bicomponent formed of a bi-component fiber may be used. The basis weight of the non-woven fabric is preferable to be in a range of 10 to 200 g/m². If the basis weight is lower than 10 g/m², the strength cannot be expected, and a basis weight exceeding 200 g/m², is not required from the viewpoint of the strength.

When the covering is conducted in the present invention, the covering member is processed into a sheet having a predetermined thickness in a thermal fusion-bonding course. A covering method comprises superposing a covering member onto a surface of a support and forcing the resulting material through between thermal rolls, or thermally press-bonding a portion of the covering member around the heat-generating composition by a pressing machine, or thermally fusion-bonding a flat bag made using a covering member in a state in which the heat-generating composition has been accommodated in the bag, while compressing the opening in the bag, or thermally fusion-bonding the bag, while compressing the entire bag.

When a high water-absorbable fiber is used as the non-woven fabric having a water-absorbability in the present invention, it is preferable that the high water-absorbable fiber has a water-absorbing ability, preferably, of 50 ml/g or more, more preferably, of 100 ml/g or more. In general, an acrylic fiber having a hydrophilic group produced by a hydrolysis using a alkali and having a crosslinked structure is preferred, and typical of such acrylic fiber are fibers of a crosslinked polyacrylate, an acrylate/acrylic ester copolymer, the hydrolyzate of a crosslinked polyacrylonitrile, an acrylate/acrylamide copolymer, a polyvinyl alcohol/acrylate copolymer and the like. It is preferable that the acrylic fiber has a thickness in a range of 1 to 10 deniers, and a length in a range of 10 to 100 mm.

The non-woven fabric for the substrate or the covering member may be formed of a highly water-absorbable fiber of the above-described type alone, but in usual, is formed using a mixture of highly water-absorbable fiber and another fiber from the viewpoint of the strength. The type of the other fiber mixed with the highly water-absorbable fiber is particularly not limited, but examples of the other fiber, which may be used, are a synthetic fiber such as a polyethylene, a polypropylene, nylon, an acrylic fiber, a polyester, a polyvinyl alcohol, a polyurethane, a natural fiber such as cotton, pilp, viscose rayon and the like. When opposite sides of the produced heater are further covered with a film or a non-woven fabric, a synthetic resin fiber such as a polyethylene, a polypropylene, nylon, an acrylic fiber, a polyester and the like is preferred, because of an excellent thermal fusion-bond property.

The rate of the highly water-absorbable fiber mixed based on the entire non-woven fabric is usually of 20% by weight or more, preferably, in a range of 30 to 80% by weight. The treatment for forming the non-woven fabric serving as a support may be any of a dry manner and a wet manner. The non-woven fabric has a thickness usually in a range of 2 to 15 mm, preferably, in a range of 3 to 12 mm, and a weight preferably in a range of 20 to 120 g/m², more preferably in a range of 30 to 100 g/m².

In the heater according to the present invention, to laminate the heat-generating composition on the substrate and covering the heat-generating composition laminated on the substrate by the covering member, a film-shaped or sheet-shaped water-absorbable material may be cut into the laminated shape of the heat-generating composition and placed on one surface of the heat-generating composition, or the opposite surfaces of the heat-generating composition may be sandwiched by the water-absorbable materials and then sealed by the covering member.

The water-absorbable material is particularly not limited, if it has a water-absorbability as a result, irrespective of whether or not a blank itself for the water-absorbable material has a water-absorbability.

Typical of the water-absorbable material are papers such as a blotting paper and domestic thin paper including a tissue paper, a foamed film and sheet (a foam such as a water-absorbable foamed polyurethane and the like), non-woven and woven fabrics formed of a fiber having a water-absorbability, non-woven and woven fabrics containing a fiber having a water-absorbability, and water-absorbable porous film and sheet.

Another example is a water-absorbable film or a sheet formed by impregnating a foamed film or sheet, a non-woven fabric or a woven fabric, or a porous film or sheet with a solution of a water-absorbent and evaporating a solvent, or by spraying, applying, incorporating, press-fitting, laminating, blending, transferring or supporting a water-absorbent to a film or sheet, irrespective of whether or not the film or sheet has a water-absorbability, thereby provide or increase a water-absorbability, or by weaving a water-absorbable fiber into a non-woven or woven fabric.

A further example of the water-absorbable material is a material which is formed by laminating and fixing a piece made by cutting a water-absorbable foamed film or sheet, papers, a non-woven fabric, a woven fabric or a porous film or sheet into a shape corresponding to the planar shape of the heat-generating composition, onto one surface or opposite surfaces of a non-permeable or air-permeable film or sheet such as a foamed film or sheet, papers, a non-woven fabric, a woven fabric or a porous film or sheet, so that the material is provided with a water-absorbability.

The papers are particularly not limited, if they have a water-absorbability, but examples of the papers are a thin paper such as a tissue paper, a crape paper and craft paper; a liner paper; a thick paper such as a corrugated cardboard core, a coated plank and the like; or a laminate made from two or more of them.

The water absorbent may be any absorbent, if it has a water-absorbability, and examples thereof are the water absorbents given in the description of the heat-generating composition.

In cases of a substrate and a covering member having a water-absorbability and poor in thermal fusibility and thermal adhesion, the substrate and the covering member may be thermally adhered or stuck to each other with a hot-melt adhesive layer or a hot-melt self-adhesive layer interposed there between. The pressing and the heating may be conducted as desired.

When a substrate having a water-absorbability is a laminate comprising a heat-sealable non-woven fabric, a water-absorbable non-woven fabric and a film or sheet formed of a synthetic resin (an air-permeable or non-permeable film or sheet), it is preferable that the heat-sealable non-woven fabric is hydrophobic and the water-absorbable non-woven fabric is hydrophilic, because they exhibit an excellent heat-sealability an excellent water-absorbability.

Examples of the heat-sealable non-woven fabric are a non-woven fabric made of a polyolefinic resin, a non-woven fabric made of poryurethan, a non-woven fabric made of a polyester, and a composite non-woven fabric of a polyester and a polyethylene. Other examples are a laminated non-woven fabric and a composite spon-bonded non-woven fabric formed from a polyester non-woven fiber and a polyethylene non-woven fiber.

The other example of the heat-sealable non-woven fabric is a non-woven fabric made of a fiber into a double structure comprising a fiber core having an outer periphery coated with a coating layer, wherein the core is formed of a polyester fiber or a polypropylene fiber, and the covering layer is formed of a polyethylene.

A further example of the heat-sealable non-woven fabric is a composite fiber non-woven fabric comprising a polyethylene fiber layer whose periphery is surrounded by a extremely fine polyester fiber layer with an extremely fine span bond interposed axially therebetween.

When each of the substrate and the covering member is a laminate, for example, the substrate is comprised of a reinforcing layer and an air-permeability control layer, and an oozing-preventing layer and a water-absorbable layer, and the covering member is comprised of a water-absorbable layer and an air-permeable layer or a non-permeable layer. For example, the reinforcing layer is formed of any one of various non-woven fabrics; each of the air-permeability control layer and the oozing-preventing layer is an air-permeable or non-permeable film or sheet formed of a synthetic resin such as a polyolefin, a polyester and the like; the water-absorbable layer is a non-woven fabric formed of a water-absorbable material such as a paper, a pulp, cotton, rayon and the like.

In a sheet-shaped heater made by laminating a sherbet-like heat-generating composition on a film-shaped or sheet-shaped support having a water-absorbability, it is preferable that the support has a water-absorbing ability of 5 g/m² or more.

The basic weight of the non-woven fabric such as the heat-sealable non-woven fabric and the water-absorbable non-woven fabric is preferably in a range of 5 to 500 g/m², more preferably in a range of 10 to 350 g/m² in order to manifest a required mechanical strength, a heat-sealability and a water absorbability.

The thickness of each of the film made of the polyolefinic resin, the film made of the polyurethane resin and the film made of polyester resin is preferably in a range of 5 to 500 μm, more preferably in a range of 10 to 350 μm in order to manifest a required mechanical strength and a heat-sealability.

The basic weight of the non-woven fabric made of the thermoplastic resin is preferably in a range of 5 to 500 g/m², more preferably in a range of 10 to 350 g/m² in order to provide enhancements in required mechanical strength and heat-sealability.

A super-thin heater according to the present invention is formed by the printing or the coating. However, if the heater is formed thinly, the exothermic reaction weight per unit time is reduced, when only the depressurization based on the consumption of oxygen in the air by the heat-generating composition within the bag occurs. As a result, it may be impossible in some cases to maintain a depressurized state of a degree enough to be able to prevent the movement and offsetting of the heat-generating composition. It is more preferable if the heater can be used irrespective of the depressurized state.

In such a case, it is preferable that the heat-generating composition shaped is covered in a net shape or a zigzag shape (covered by a network polymer) by the application, the spraying, the coating, the printing, the melt-blowing and the like of a polymer (a self-adhesive or a thermoplastic polymer is preferred) or an emulsion containing the polymer, whereby the whole or a portion of the heat-generating composition is fixed to the substrate and/or the covering member and prevented from being displaced and moved to one side. This also prevents the destroying of the shape. The polymer may be either thermoplastic or thermosetting, but one example thereof is a self-adhesive which may be used for a polymer material, a thermoplastic elastomer and a self-adhesive layer, which will be described hereinafter. A polymer material used for the substrate and the covering member is also an example of the thermoplastic polymer. Of course, a combination of them and the polymers having weak and strong tack strength may be also used.

The net shape may be any one, if it provides an air-permeability, and an air-permeable film is useful.

It is required that each of the substrate, the underlay member and the covering member has a required mechanical strength such as a tensile strength and moreover, in order to enhance the conformability to the body surface, it is preferable that the entire heater is soft.

More specifically, the heater according to the present invention may be applied further appropriately to a joint portion such as an elbow, a knee and the like, a curved portion, an expandable/contactable portion and a flexible portion of a human body. Moreover, in order to allow the heater to further easily follow the expandable/contractable portion and the flexible portion, it is desirable that each of the substrate and the covering member, namely, the wrapping member for the heater is formed of a stretchable film or sheet, particularly, an expandable/contractable film or sheet.

The each of expandable/contractable substrate and covering member, namely, the expandable/contractable film is particularly, not limited if it is formed of a expandable/contractable blank, but examples of them are a natural rubber, a synthetic rubber or a thermoplastic elastomer.

The substrate and/or the covering member used for the heater according to the present invention include those made laminating a plurality of layers having the above-described various functions in the thickness-wise direction, as described above.

By physically forming the ruggedness on the surface of each of the substrate, the underlay member and the covering member, the bondability thereof to the heat-generating composition may be enhanced by the close adhesion resulting from the absorption of water from the heat-generating composition and by the rugged shape, whereby the movement and the offsetting thereof may be prevented.

When each of the substrate, the underlay member and the covering member is a smooth film or a smooth sheet, the surface thereof maybe roughened (formed into a rugged shape), or a foamed film, a foamed sheet, a paper, a non-woven fabric, a woven fabric or a porous film or sheet may be used to prevent the movement and offsetting of the heat-generating composition.

The surface of each of the substrate, the underlay member and the covering member may be roughened (rugged) by a physical treatment such as a corona treatment or the like, and/or the whole or a portion of the heat-generating composition may be embedded into or a bonded to a layer formed by an iron powder, activated carbon, a water-absorbable polymer, a thickener, a coagulation assistant and/or a binder as described above, or a water-absorbable layer formed of a film-shaped or sheet-shaped water-absorbable material, whereby the movement and offsetting of the heat-generating composition may be further prevented.

Each of the substrate, the underlay member and the covering member may be formed of a non-permeable or air-permeable film or sheet or a water-absorbable blank, or a water-absorbable material having a water-absorbability is laminated to one surface or opposite surfaces of each of the substrate, the underlay member and the covering member, whereby portions of the substrate and/or the underlay member and/or the covering member which contact with the heat-generating composition are rugged, and thus, the bondability thereof to the heat-generating composition may be enhanced by the close adhesion resulting from the absorption of water from the heat-generating composition and by the rugged shape, whereby the movement and the offsetting thereof may be prevented.

It is preferable that the ruggedness formed on the whole or a portion of the surface layer of the sherbet-like heat-generating composition and/or the underlay member is formed at a depth in a range of ⅕ to ⅘ of the thickness of the heat-generating composition layer.

It is also preferable that the ruggedness formed on the whole or a portion of the surface layer of the sherbet-like heat-generating composition and/or the underlay member is formed by an embossing pattern roll and moreover, the emboss angle of the ruggedness is in a range of 90 to 120 degrees.

The thickness of each of the substrate, the underlay member and the covering member is preferably in a range of 10 to 5,000 Mm, more preferably in a range of 10 to 2,500 μm, further preferably in a range of 12 to 1,000 μm from the viewpoint of the provision of a required mechanical strength is provided and from the viewpoint of the provision of a required softness.

If the thickness of each of the substrate, the underlay member and the covering member is smaller than 10 μm, a required mechanical strength is not provided. On the other hand, if the thickness of each of the substrate, the underlay member and the covering member exceeds 5,000 μm, the softness of such material is reduced even if it is a foam such as a sponge or the like and as a result, the conformability of the heater to the body surface is remarkably reduced; the heater is stiff, resulting in a degradation in feeling of use, and the thickness of the entire heater is increased. Therefore, the thickness exceeding 5,000 μm is not preferable.

As for the air-permeability of the air-permeable portion of each of the substrate and the covering member, a moisture vapor transmission rate (L80 to 4,000 H type in a Lyssy process) is preferably in a range of 50 to 10,000 g/m²·24 hr, more preferably in a range of 200 to 6,000 g/m²·24 hr in order to achieve a temperature effect of the heater according to the present invention.

If the moisture vapor transmission rate is smaller than 50 g/m²·24 hr, the amount of heat generated is reduced, whereby a sufficient warm heat effect is not obtained. On the other hand, if the moisture vapor transmission rate exceeds 10,000 g/m²·24 hr, it is feared that the heat-generation temperature is higher, resulting in a problem arisen in safety, and the heat-generation time is shortened.

The underlay member maybe air-permeable or non-permeable. If the underlay member is air-permeable, it is preferable that the air-permeability of the underlay member is equivalent to that of each of the substrate and the covering member.

A self-adhesive layer or a gel layer may be formed on the whole or a portion of either one of exposed surfaces of the heater according to the present invention. It is preferable that at least a portion of the other exposed surface has an air-permeability.

The self-adhesive layer or the gel layer is particularly not limited, if it is a layer capable of being stuck or fixed to a skin or a cloth. A particle example of the self-adhesive layer or the gel layer is a layer formed of a gel component and/or a self-adhesive.

The self-adhesive layer or the gel layer can be formed directly on either one of exposed surfaces of the substrate or the covering member. In this case, it is preferable that the exposed surface of the substrate or the covering member is roughened, or formed of a film or sheet having a rough surface such as a paper, a woven fabric, a knitted fabric, a non-woven fabric, a foamed film, in order to increase the bonding force of the self-adhesive layer or the gel layer to the substrate or the covering member.

Examples of the self-adhesive layer are layers formed of a solvent-type self-adhesive, an emulsion-type self-adhesive, a hot melt-type self-adhesive, an aqueous gel and the like. Among these self-adhesive layers, a preferred one is a layer formed of a rubber-based self-adhesive, an acrylic self-adhesive or a self-adhesive containing a hot-melt type polymer substance by the following reasons: its adhesive force is varied to a relatively small extent even if such layer is warmed, and particularly, in a case of a type suitable to be applied directly to a skin, such layer has a good adhesion to a skin and moreover, less stimulates the skin. Especially, the layer formed of the self-adhesive containing the hot-melt type polymer substance exhibits a strong initial tack force, and is very excellent in adhesion, when it is warmed.

Particular examples of the self-adhesive layer are layers formed of a rubber-based self-adhesive, a vinyl acetate-based self-adhesive, an ethylene vinylacetate based self-adhesive, a polyvinyl alcohol-based self-adhesive, a polyvinyl acetal-based self-adhesive, a polyvinyl chloride-based self-adhesive, an acrylic self-adhesive, a polyamide-based self-adhesive, a polyethylene-based self-adhesive, a cellulose-based self-adhesive, a polysulfide-based self-adhesive, and a self-adhesive containing a hot-melt type polymer substance.

Particular examples of the hot-melt type polymer substance used for the heater according to the present invention are a polystyrene-based A-B-A type block copolymer, a polyethylene-based polymer compound, a saturated polyester-based polymer compound, a polyamide-based polymer compound, an acrylic polymer compound, a urethane-based polymer compound, a polyolefinic polymer compound or polyolefinic copolymer, and modified products of them and a mixture of two or more of them. Especially, a self-adhesive comprising an elastomer which is a polystyrene-based A-B-A type block copolymer and a tackifier resin (a petroleum resin or the like) is useful as a re-peelable self-adhesive.

The modified product indicates a product formed by substituting a portion of the hot-melt type polymer substance with another component to improve the nature of the hot-melt type polymer compound, e.g., the tackiness of the hot-melt type polymer compound and to change the stability of the latter.

In the A-B-A type block copolymer, an A block is a non-elastic polymer block of a monovinyl substituted aromatic compound A such as styrene, methylstyrene and the like, and a B block is an elastic polymer block of a conjugated diene such as butadiene, isoprene and the like. Particular examples of the A-B-A type block copolymer are a styrene-butadiene-styrene block copolymer (SBS), a styrene-isoprene-styrene block copolymer (SIS) and hydrogenated products of them (SEBS) and SIPS) and the like. A mixture of them may be also used.

Preferred as the gel layer is, in addition to an aqueous gel layer formed of a polyacrylic acid-based aqueous gel, a tacky layer containing a water-absorbable polymer further incorporated in the above-described in the self-adhesive, namely, tacky layers formed of a hot-melt type polymer substance, an aliphatic petroleum resin, a softening agent and a water-absorbable polymer, from the viewpoint of sanitation, because body fluids such as sweat from a skin and a secretion are absorbed and adsorbed by the water-absorbable polymer, whereby the surface of an external skin is kept clean.

The gel layer containing the water-absorbable polymer incorporated in the above-described self-adhesive and hence, the hot-melt type polymer substance, the aliphatic petroleum resin and the softener used are the same as those described above.

According to the present invention, more useful as the gel layer are one formed from 5 to 40 parts by weight of a hot-melt type polymer substance, 5 to 55 parts by weight of an aliphatic petroleum resin, 5 to 55 parts by weight of a softener and 0.5 to 10 parts by weight of a water-absorbable polymer, and particularly, one formed from 10 to 30 parts by weight of a hot-melt type polymer substance, 10 to 50 parts by weight of an aliphatic petroleum resin, 15 to 45 parts by weight of a softener and 1 to 8 parts by weight of a water-absorbable polymer.

In this case, if it is feared that the water-absorbable polymer is poor in hydrophilic nature with the tacky layer (the self-adhesive layer) and for this reason, is not dispersed homogeneously, it is preferable that the water-absorbable polymer is treated by a surfactant.

The surfactant used is particularly not limited, if it facilitates the dispersion of the water-absorbable polymer in the tacky layer of the self-adhesive, but examples thereof are an anionic surfactant, a cationic surfactant, a nonionic surfactant and an amphoteric surfactant.

As desired, an additive or additives may be added in an appropriate amount to the self-adhesive layer or the gel layer, such as a medicinal glass, a herb, an aromatic, a lotion, a milky lotion, a wet compress drug, an endermically absorbable drug, another self-adhesive, a tackifier, an age resistor, a filler, a tack-adjusting agent, a tack improver, a colorant, an antifoaming agent, a thickener, a modifier, a mildew-proofing agent, an anti-fungus agent, a germicide (microbicide), a deodorant or a deodorizer, a far infrared ray-emitting material, a magnetic material and the like.

The endermically absorbable drug is particularly not limited if it is capable of being endermically absorbed, but particular examples thereof are a skin irritant, a pain-killer, central nerve sedating drugs (a sleeping sedative, an anti-epileptic drug and a psychiatric drug), a diuretic, a hypotensive drug, a coronal vasodilator, a cough medicine, an antihistamine, a drug for arrhythmia, a cardiotonic drug, an adrenocortical hormone drug, a local anesthetic and the like. These drugs may be used alone or in the form of a mixture of two or more of them.

If the endermically absorbable drug is incorporated into the self-adhesive layer in the heater according to the present invention, it is possible to enhance a local therapeutic effect and a systemic therapeutic effect and to permit the drug to be absorbed into a blood circulated actively by a warming effect to circulate the drug further effectively to various portions within a human body. Therefore, the incorporation of the endermically absorbable drug is extremely preferable for further enhancing the dosage effect to the various portions.

In the heater according to the present invention, it is desirable that a powder or a molded product of ceramic emitting far infrared rays is provided in the heat-generating composition and/or in the heater at a location on the side of the self-adhesive layer for the purpose of revealing a far infrared ray effect.

The thickness of the self-adhesive layer or the gel layer is particularly not limited, but is preferably in a range of 5 to 1,000 μm, more preferably in a range of 10 to 500 μm, further preferably in a range of 15 to 250 μm. If the thickness of the self-adhesive layer is smaller than 5 μm, a required tack strength is not provided. On the other hand, if the thickness exceeds 1,000 μm, the self-adhesive layer or the gel layer is bulky, resulting in a degradation in application feeling but also in a degradation in economy.

The content of the drug is particularly not limited, if it is within such a range that a drug effect can be expected, but the content of the endermically absorbable drug is preferably in a range of 0.01 to 25 parts by weight, further preferably in a range of 0.5 to 15 parts by weight, based on 100 parts of by weight of the self-adhesive from the viewpoints of a pharmacological effect, an economy, a tack strength and the like.

In addition, if the self-adhesive layer has a water-permeability, i.e., a function to permeate a body fluid such as sweat oozed out of a skin toward the support, the permeated body fluid is absorbed into the water-absorbable layer to prevent a decrease in tack strength. As a result, it is possible to prevent the peeling-off of a warming affixing agent and to prevent a reduction in adhesion to an external skin.

An example of such a self-adhesive layer having the water-permeability is a layer formed by applying a radiation such as an electron beam of a high energy, a laser and the like to the self-adhesive layer, or a self-adhesive formed of a self-adhesive containing a hot-melt type polymer substance as described above into a net shape.

The water absorption rate of the water-absorbable material is preferably in a range of 2.5 to 35% by weight, more preferably in a range of 5 to 30% by weight in terms of a percentage of an amount of water absorbed from the water in the heat-generating composition.

A method for measuring a rate (% by weight) of absorption of the water in the heat-generating composition into the wrapping member will be described below.

Each of the substrate and the covering member constituting the wrapping member is punched into a circular shape having a diameter of 60 mm and then dried for 24 hours under a reduced pressure of 1 to 2 Pa at a temperature of 55° C. to form each of a substrate piece and a covering member piece. A water absorption rate of each of these pieces is measured. In this case, the weight of the substrate piece is represented by K1 (g) and the weight of the covering member piece is represented by H1 (g).

Then, a heat-generating composition is laminated through a die onto the dried substrate piece, so that the resulting laminate has a circular shape having a diameter of 60 mm and a thickness of about 850 μm. The weight K1 (g) of the substrate piece is subtracted from the total weight C(g) of the laminate to determine the lamination weight S (g) of the heat-generating composition.

If the content of water in the laminated heat-generating composition is P% by weight, the total amount of water in the laminated heat-generating composition is S×P/100(g).

Further, the dried covering member piece is laminated on an exposed surface of the heat-generating composition on the substrate piece, and an acrylic plate having a thickness of about 1 mm is then placed on the covering member piece laminated. Subsequently, a weight of 2.5 Kg is placed on the acrylic plate and left to stand for 5 hours.

Thereafter, the substrate piece and the covering member piece are separated from each other, and the heat-generating composition deposited to each of the substrate piece and the covering member piece is removed substantially completely. Then, the weight of each of the substrate piece and the covering member piece is measured. In this case, the weight of the substrate piece is represented by K2 (g), and the covering member piece is represented by H2 (g).

Then, the substrate piece and the covering member piece are dried for 24 hours at a temperature of 55° C. and under a reduced pressure of 1 to 2 Pa, and the weights thereof are measured. The weight of the substrate piece is represented by K3 (g), and the weight of the covering member piece is represented by H3 (g).

A value determined according to W=100×{(K2+H2)−(K3+H3)}/{S×P/100} is defined as a water absorption rate.

A heater produced in the above manner can be used for the warming in a winter season, and in addition, for a disease such as stiffneck, a muscular pain, stiff muscle, lumbago, the cold of limbs, neuralgia,a rheumatism, a bruise, a sprain and the like, and a therapeutic effect caused by the warming heat can be expected sufficiently by use of the heater.

A process for producing a heater according to the present invention will be described below.

A first process for producing a heater according to the present invention (which will be referred to as a first process according to the present invention hereinafter) comprises a first step of preparing a heat-generating composition by blending and mixing components, a second step of conducting the shaping of the heat-generating composition such as the transferring, the lamination, the die pressing and the force-through die molding and the like, and a fourth step of placing a covering member for sealing. The first, second and fourth steps are carried out sequentially in the named order.

Examples of the second step are a second A step of conducting the shaping using a stirring screwed head and a forcing-in plate provided with a vibrator (at which a magnet may be mounted under the forcing-in plate, and a second B step of conducting the shaping using a stirring screwed head, a rubbing/cutting plate and a magnet mounted under the rubbing/cutting plate. As required, the heat and the rubbing/cutting plate may be vibrated.

A second process for producing a heater according to the present invention (which will be referred to as a second process according to the present invention hereinafter) comprises a first step for blending and mixing components to prepare a heat-generating composition, a second step of conducting the shaping of the heat-generating composition such as the transferring, the lamination, the die pressing and the force-through die molding and the like, a third step of laminating or scattering at least one selected from a water-absorbing agent, an iron powder, a carbon component, a water-absorbable polymer, a binder, a thickener, a coagulation assistant and a water-absorbing material on the heat-generating composition, a fourth step of placing a covering member, and a fifth step of conducting the punching or stamping. The first, second, third, fourth and fifth steps are carried out sequentially in the named order.

A third process for producing a heater according to the present invention (which will be referred to as a third process according to the present invention hereinafter) comprises a first step of blending and mixing components to produce a heat-generating composition, a second step of conducting the molding of the heat-generating composition such as the transferring, the lamination, the force-in die molding, and the forcing-through die molding and the like, a third A step of placing a network polymer material on the molded heat-generating composition, a fourth step of placing a covering member, and a fifth step of conducting the punching or stamping. The first, second, third A, fourth and fifth steps are carried out sequentially in the named order.

A fourth process for producing a heater according to the present invention (which will be referred to as a fourth process according to the present invention hereinafter) comprises a first step of blending and mixing components to produce a heat-generating composition, a second step of conducting the molding of the heat-generating composition such as the transferring, the lamination, the die pressing and the force-through die molding and the like, a third B step of conducting the dehydration such as the sucking dehydration, the centrifugal dehydration, the compressing dehydration, the depressurizing hydration, the compressing/depressurizing hydration and the like, a fourth step of placing a covering member, and a fifth step of conducting the punching or stamping. The first, second, third B, fourth and fifth steps are carried out sequentially in the named order.

A fifth process for producing a heater according to the present invention (which will be referred to as a fifth process according to the present invention herein after) comprises a sixth step of interposing the heater produced by each of the first to fourth processes according the present invention between two films or sheets, punching or stamping the two films or sheets into a size larger than that of the heater, simultaneously with or after the interposition, and sealing the two films or sheets at a peripheral edge of the heater simultaneously with or after the punching or stamping. The sixth step is carried out after the final step in each of the above-described processes. If the films or sheets have an air-tightness, they function as a preserving outer bag.

The first step, the second step, the second A step, the second B step, the third step, the third A step, the third B step, the fourth step, the fifth step and the sixth step may be combined as desired out of order to produce the heater according to the present invention, wherein some of the steps may be repeated.

In the producing process, for example, the first step, the second A step, the third B step, the third A step, the fourth step, the fifth step and the sixth step may be carried out sequentially in the named order, or the third step, the first step, the second step, the third A step, the fourth step and the fifth step may be carried out sequentially in the named order.

Each of the steps may be carried out in an atmosphere of an inert gas such as nitrogen and argon in order to prevent the iron powder from being oxidized by contacting with oxygen in the air.

The steps will be described below in detail.

Examples of the sherbet-like heat-generating composition are those described above.

At the first step, predetermined amounts of components such as an iron powder, activated carbon, an oxidation promoting agent and water and further, as desired, a water-retention agent, a heat-generation assistant, a hydrogen-generation inhibitor and a foaming agent are first mixed together. The mixing order is particularly not limited, but all of the components may be thrown in to a mixer and then mixed homogenously. Alternatively, only the solid components of all of the components may be thrown sequentially group by group, or all of the solid components may be thrown simultaneously and mixed homogenously in the mixer, and water or an aqueous solution or suspension of a metal chloride may be then thrown into the resulting mixture and mixed together, whereby the sherbet-like heat-generating composition may be produced. In this case, the quality of the produced heat-generating composition is stabilized, which is desirable, because the solid components are thrown into the mixer, and the water is then thrown into the mixture and mixed together.

If the mixing and transportation of the components are carried out using a screw, the iron powder and the carbon component or portions thereof, the saline (or water) or a portion thereof may be first thrown, so that the iron and the carbon component may be mixed sufficiently in a contacting manner. After the elapse of a certain time, the other components may be thrown, and the resulting mixture may be transported while being mixed by the screw.

The mixer used at the first step according to the present invention is particularly not limited, if it mixes the components forming the sherbet-like heat-generating composition according to the present invention, but particular examples of the mixer are a ribbon mixer, a Spartan mixer, a screw blender, a roll mixer, a Banbury mixer, a mixing/extruding screw and the like.

At the second step, the heat-generating composition prepared at the first step is die-extruded onto and laminated to at least one predetermined region on an upper surface of a film-shaped or sheet-shaped substrate. The substrate is similar to that given in the description of the heater according to the present invention.

At the second step, the heat-generating composition is laminated in any shape on the upper surface of the substrate by a printing such as a screen printing or a coating.

At the second A step, the heat-generating composition is shaped by the transferring, the lamination, the force-in die molding, the force-through die molding and the like, while being vibrated.

Any vibrating means may be used, if it vibrates the sherbet-like heat-generating composition, but for example, an eccentric motor, a piezoelectric element or a usually used vibrator using air or the like may be used.

At the second A step, the molding of the heat-generating composition such as the transferring, the lamination, the force-in die molding and the like accompanied by the pushing-in by a pushing plate is carried out, while providing the vibration to the heat-generating composition.

The pushing plate may be any one, if it can push the sherbet-like heat-generating composition into a die, but examples thereof are plates which are preferably formed of a plastic such as an acrylic resin, a vinyl chloride resin, a polyethylene and the like, a metal such as iron and a stainless steel or a combination of them, and which have a spring property.

At the second B step, the heat-generating composition is supplied into a die, while being stirred by a cylindrical head provided with a stirring screw. At this time, a vibration may be provided to the head. A substrate, a die plate and a plate receiving them (a belt of a belt conveyer and the like) are passed in unison with one another between a rubbing/cutting plate which is fixed substantially in front of and below the head, and a magnet mounted below the rubbing/cutting plate. The heat-generating composition is attracted through the die onto the substrate by the magnet and at the same time, the surface of the heat-generating composition is rubbed off along the die by the rubbing/cutting plate and thus shaped. Thereafter, the die is separated from the substrate. The magnet may be any one, if it has magnetism, and examples thereof are a permanent magnet, an electromagnet and the like.

At the second step ,the second step A and the second B step, the heat-generating composition may be laminated at one point or at two or more points in a widthwise direction on the upper surface of the substrate, or in a zigzag fashion in a lengthwise direction on the substrate.

The third step is a step of laminating or scattering at least one component selected from the iron powder, the carbon component, the water-absorbing agent, the water-absorbable polymer, the binder, the thickener and the coagulation assistant onto the upper surface of the shaped heat-generating composition laminated to the at least one predetermined region on the upper surface of the film-shaped or sheet-shaped substrate.

At the third A step, a network polymer is mounted on the shaped heat-generating composition.

At the third B step, the dehydration of the heat-generating composition such as the suction dehydration, the centrifugal dehydration is carried out.

A film-shaped or sheet-shaped water-absorbing material may be applied to one or opposite surfaces of the sherbet-like heat-generating composition laminated according to the present invention, so that a portion of water in the sherbet-like heat-generating composition according to the present invention may be absorbed into the water-absorbing material. Examples of the water-absorbing material are those described above.

Therefore, a covering member is placed to cover the at least one component selected from the iron powder, the carbon component, the water-absorbing agent, the water-absorbable polymer, the binder, the thickener and the coagulation assistant laminated or scattered on the laminate of the sherbet-like heat-generating composition and/or the water-absorbing material.

The third A step is a step of placing the network polymer onto the surface of the laminate of the sherbet-like heat-generating composition according to the present invention. This placement is conducted by a usual working technique such as the melt-blowing, the printing, the application and the like. Thus, the laminate of the sherbet-like heat-generating composition according to the present invention can be fixed more strongly to the substrate. If the polymer has a tacky property, the substrate and/or the heat-generating composition and the covering member are stuck together.

The third B step is a step of producing a sheet-shaped heater by filtering the heat-generating composition mounted by the force-in die molding, the lamination or the like on the water-permeable substrate such as a non-woven fabric and a filter paper and, as required, further dehydrating the heat-generating composition by sandwiching it between canvases and pressing them. It is preferable that this step is carried out in an atmosphere of an inert gas such as nitrogen and argon in order to prevent the iron powder from being oxidized by the contact with oxygen in the air during this step.

The fourth step is a step of a placing a film-shaped or sheet-shaped covering member to cover the laminate of the sherbet-like heat-generating composition according to the present invention to seal the laminate. Examples of the covering member used at this step are similar to those given in the description of the heater according to the present invention. In this case, it is desirable that the substrate and the covering member are sealed at a peripheral portion of the laminate of the heat-generating composition by the sticking, the heat bonding or the heat fusion. In the process according to the present invention, at least a portion of the substrate and the covering member has an air-permeability.

At the fifth step, the laminate is punched or stamped into a predetermined shape. This punching may be carried out with the laminate left stationary. In this case, a plurality of the laminates arranged in a direction of feeding of the laminates and in a widthwise direction perpendicular to the feeding direction may be punched simultaneously to form a large number of heaters at one time, leading to a reduction in cost.

In this process, however, for example, when a heat-generating composition is laminated on a roll film-shaped or roll sheet-shaped substrate, while feeding the substrate, for example, at a speed in a range of 30 to 200 m/sec, and a roll film-shaped or roll sheet-shaped covering member is placed onto the heat-generating composition by a method of guiding the covering member on a roll, thereby producing a laminate, the laminate can be punched into any shape at the punching step using a roll press or the like, while being fed, for example, at a feed speed, for example, in a range of 30 to 200 m/sec, thereby producing heaters according to the present invention continuously. Of course, the laminate may be once wound into a roll, and from the roll,heaters may be punched, while being unrolled intermittently.

In this case, a further large number of heaters according to the present invention can be produced in a short time by continuously punching the laminate at one point or two or more points in a widthwise direction, or continuously punching a plurality of laminates in a zigzag fashion in a lengthwise direction, thereby providing a further remarkable reduction in cost.

The laminate is punched into a shape enough to cover any site depending on the application of the produced heater. Namely, the laminate produced in the third process according to the present invention is punched into any desired shape, but a heater produced by this punching can be of any shape and can be used for various sites such as a foot, a shoulder, a waste and the like without being particularly limited to a particular application.

### EXAMPLES

Particular examples of the present invention will be described in detail with reference to the accompanying drawings. However, the examples are given for only the purpose of explaining the present invention and should not be construed to limit the present invention, and various modifications and variations may be made without departing from the spirit and scope of the present invention.

### Example 1

100 Grams of an iron powder, 6 grams of activated carbon and an aqueous solution of sodium chloride (7 grams of NaCl and 55 g of water) were mixed thoroughly to prepare a sherbet-like heat-generating composition. A water mobility value in this case was 30.

The heat-generating composition 2 was laminated on a polyester non-woven fabric 3d (having a thickness of 210 μm) containing a water-absorbable polymer and provided on one surface of a non-permeable polyethylene film 3b having a thickness of 40 μm of a substrate 3 into a rectangular shape having a width of 5 cm, a length of 10 cm and a thickness of about 0.9 mm by a force-in die molding process using a rubbing/cutting plate. Then, a tacky polymer 8 comprising a styrene-isoprene-styrene block copolymer was placed in a net shape on an upper surface of the resulting laminate by a melt-blow process, and a covering member 4 was placed thereon. Subsequently, a peripheral portion of the laminate was sealed by a heat sealing, and a portion around the sealed portion was cut, thereby producing a heater 1 according to the present invention, which had a width of 7 mm at the sealed peripheral portion 9 and which was ultra-thin.

The moisture vapor transmission rate of the covering member 4 was 400 g/m²·24 hr in a Lyssy process. The covering member 4 used was one made by laminating a non-woven fabric of nylon having a thickness of 150 μm on a porous film 4a made of a polyethylene and having a thickness of 50 μm.

The produced heater 1 was accommodated in a sealed manner into an outer bag having an air-tightness. The heater 1 was left to stand for 24 hours after the accommodation thereof in order to gradually absorb a portion of water therein into the substrate. Thereafter, the outer bag was broken and subjected to a heat-generating test under the following conditions:

First, the heater was placed on a central portion of a steel plate adjusted to 30° C. and having a size of 300×300 mm. A temperature sensor was affixed to a surface of the feature, and a single flannel fabric having a thickness of 6 mm and a size of 80×80 mm was superposed thereon. In this case, the flannel fabric must be superposed so that a peripheral portion of the heater and a peripheral portion of flannel fabric were matched substantially with each other. Two flannel fabrics having a size of 600×600 mm and having a cotton content of 100% were placed on the heater, so that a steel plate.

A heat-generating characteristic (a heat-generation reached temperature/heat-generating time curve) of the heater was measured under the above-described test conditions. The measurement of a heat-generation reached temperature was carried out in a thermostatic chamber at a temperature of 20° C. and a humidity of 65% using a data collector.

In the heat-generation test, the heat-generating temperature was raised to about 38° C. in about 1 to 2 seconds, and thereafter, the heat was generated at 38 to 41° C. over 3 hours or more. The heat-generation was observed uniformly over the entire surface.

### Example 2

100 Grams of a reduced iron powder containing 80% of particles having a particle size equal to or smaller than 200 meshes, 6 grams of activated carbon made of coconut husks and 8 grams of perlite (having a particle size of 0.05 to 0.5 mm) as a water-retaining agent were mixed into 55 grams of an aqueous solution of sodium chloride, and they were stirred to provide a sherbet-like heat-generating composition. The water mobility value of the heat-generating composition was 45.

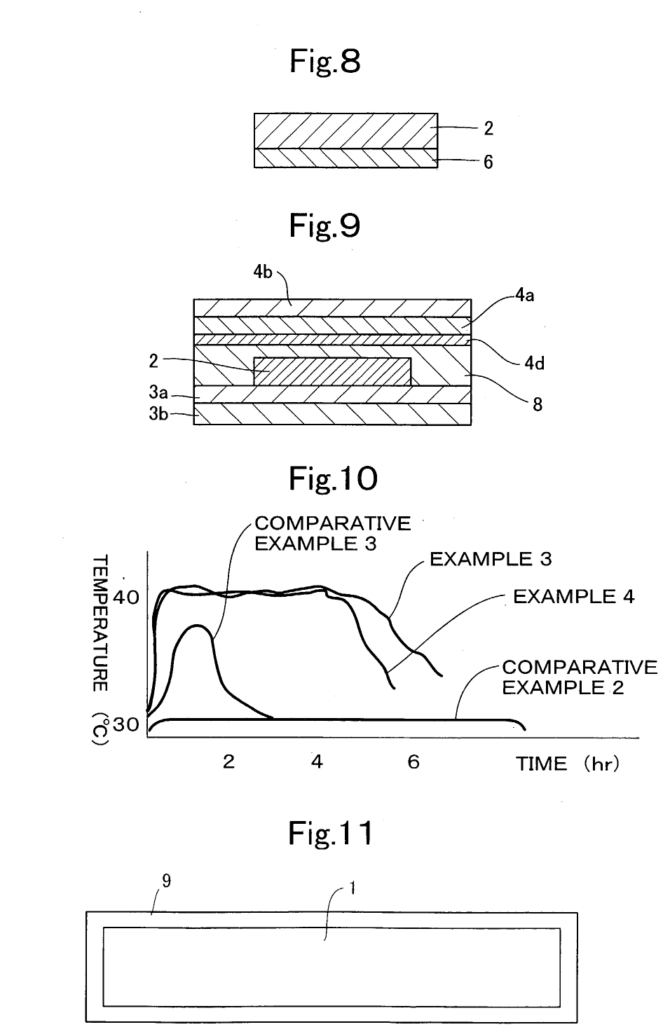

The sherbet-like heat-generating composition 2 was poured into a Buchner funnel on which a filter paper 6 having a diameter of 110 mm was laid, whereby the composition 2 was filtered in a sucked manner to remove a surplus amount of water to produce a sheet-shaped product having a water content of about 40% as a heater (see FIG. 8).

The produced sheet-shaped heater including the filter paper 6 had a thickness of 2 mm, and was accommodated in a sealed manner into an outer bag having an oxygen non-permeability.

Then, the sheet-shaped heater was taken out of the outer bag and cut into a size of 5×5 cm, and an exothermic reaction of the heater was caused at a room temperature of 20° C. in the air having a relative humidity of 65% to generate a heat on a foamed styrol. After lapse of 5 minutes, the temperature of the heater reached 50° C. or more. Thus, the heater had a heat-generating performance sufficient for practical use.

### Comparative Example

100 Grams of a reduced iron powder containing 80% of particles having a particle size equal to or smaller than 200 meshes, 7.5 grams of activated carbon made of coconut husks and 1 gram of CMC were mixed into 36 grams of an aqueous solution of 14 grams of NaCl dissolved in water in a nitrogen gas atmosphere to produce a creamy heat-generating composition. The water mobility value of the creamy heat-generating composition was 10. The creamy heat-generating composition was treated in the same manner as in Example 2, but a surplus amount of water could be little discharged, and a fairly large amount of water was left in the heat-generating composition.

In a heat-generation test similar to that in Example 2, the temperature of the heater was lower than 30° C., and a sufficient heat-generating performance of the heater could not be exhibited.

### Examples 3 and 4 and Comparative Examples 2 and 3

Heat-generating compositions were produced using 100 grams of an iron powder, 7 grams of table salt (NaCl) as an oxidation promoter, 55 grams of water and 6 grams of activated carbon. In addition to these components, 8 grams of terra-balloon which was a volcanic ash material having a water-retaining power was further used in Example 3, and 12 grams of terra-balloon which was a volcanic ash material having a water-retaining power was further used in Example 4. The water mobility values of the heat-generating compositions were 26 and 17, respectively.

In Comparative Examples 2 and 3, creamy heat-generating compositions were produced using 1 gram of CMC as a thickener in Comparative Example 2 and 10 grams of CMC as a thickener in Comparative Example 3, in place of the water-retaining agent. The water mobility values of the heat-generating compositions were 10 and 6, respectively.

In Example 3, the sherbet-like heat-generating composition 2 was laminated on a polyester non-woven fabric 3d (having a thickness of 210 μm) containing a water-absorbable polymer and provided on one surface of a non-permeable polyethylene film 3b having a thickness of 40 μm of a substrate 3 into a rectangular shape having a width of 5 cm, a length of 10 cm and a thickness of about 0.9 mm by a force-in die molding process using a rubbing/cutting plate. Then, a tacky polymer 8 comprising a styrene-isoprene-styrene block copolymer was placed in a net shape on an upper surface of the resulting laminate by a melt-blow process, and a covering member 4 similar to that used in Example 1 and having a water-absorbable paper 4d provided on its back side was placed thereon, so that the water-absorbable paper 4d was in contact with the network polymer 8. Subsequently, a peripheral portion of the laminate was sealed by a pressure sealing, and a portion around the sealed portion was cut away, thereby producing a heater 1 according to the present invention, which had a width of 7 mm at the sealed peripheral portion and which was ultra-thin. Then, the heater was accommodated in a sealed manner into an outer bag having an air-tightness.

Even in Example 4 and Comparative Examples 2 and 3, heaters were fabricated in the same manner as in Example 3 and subjected to a heat-generation test similar to that in Example 1.

Results of measurement of heat-generating characteristics of the heaters in Examples 3 and 4 and Comparative Examples 2 and 3 are shown in FIG. 10. As a result of the test, it was seen that high heat generation-reached temperatures and long durations were obtained in Examples 3 and 4, respectively. It was also seen that the heat generation-reached temperatures in Examples 3 and 4 were 2° C. or more higher than those in Comparative Examples 2 and 3, and the durations for maintaining 40° C. or more were 2 hours or more longer than those in Comparative Examples 2 and 3.

### Example 5

A mixture made by homogeneously mixing 100 grams of an iron powder, 8 grams of activated carbon, 0.2 grams of hydrated lime, 8 grams of terra-balloon and 1 gram of wood flour was mixed thoroughly with an aqueous solution of sodium chloride (comprising 1 grams of NaCl and 55 grams of water) to produce a sherbet-like heat-generating composition. The water mobility value of the heat-generating composition was 16.

Then, the sherbet-like heat-generating composition was treated in the same manner as in Example 1, except that before a tacky polymer comprising a styrene-isoprene-styrene block copolymer having a thickness of 100 μm was provided in a net shape after formation of the sherbet-like heat-generating composition, a water-absorbable polymer was manually scattered as a water-absorbing agent onto the surface of the heat-generating composition to form a water-absorbing layer (METSUKE of 20 g/m²). In this manner, a ultra-thin heater shown in FIG. 11 and according to the present invention was produced. The heater was subjected to a heat-generation test similar to that in Example 1 to provide similar results.

### Example 6

A mixture made by homogeneously mixing 100 grams of an iron powder, 6 grams of activated carbon, 0.2 grams of hydrated lime, 8 grams of terra-balloon which was a volcanic ash material having a water-retaining power was mixed thoroughly with an aqueous solution of sodium chloride (comprising 7 grams of NaCl and 55 grams of water) to produce a sherbet-like heat-generating composition. The water mobility value of the heat-generating composition was 26.

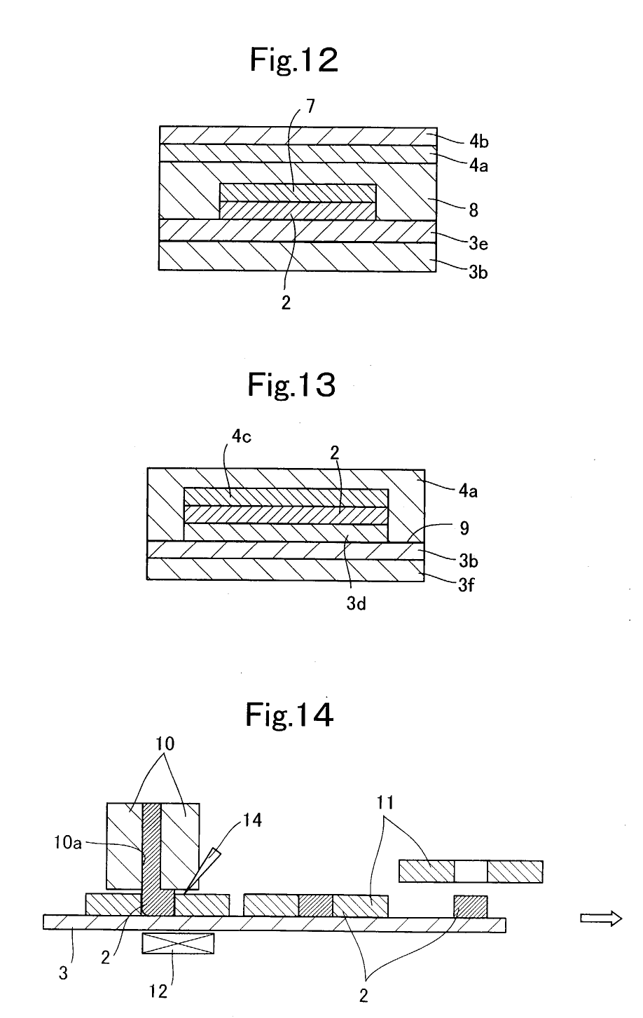

The sherbet-like heat-generating composition 2 was molded on a water-absorbable paper 3e (having a thickness of 3 mm) affixed to one surface of a non-permeable polyethylene film 3b having a thickness of 40 μm on a substrate 3 into a prolong shape having a width of 40 mm, a length of 200 mm and a thickness of about 1 mm by a force-through die molding process using a rubbing/cutting plate, and a water-absorbable polymer 7 was scattered uniformly on the heat-generating composition. Then, a tacky polymer 8 comprising a styrene-isoprene-styrene block copolymer was provided in a net shape on an upper surface of the resulting heat-generating composition by a melt-blow process, and a covering member 4 was placed thereon. Subsequently, a peripheral portion of the resulting laminate was sealed by a heat sealing, and a portion around the sealed portion was cut away, thereby producing a heater (see FIG. 12) according to the present invention, which had a width of 7 mm at the sealed peripheral portion and which was ultra-thin.

The covering member 4 used was one made by laminating a non-woven fabric of nylon having a thickness of 150 μm on a porous film 4a made of a polyethylene and having a thickness of 50 μm. The moisture vapor transmission rate of the covering member 4 was 400 g/m²·24 hr in a Lyssy process.

The produced heater was accommodated in a sealed manner into an outer bag.

In the same manner as in Example 1, the outer bag was broken, and the heater according to the present invention was taken out and subjected to a heat-generation test. As a result, a good heat-generating characteristic was shown as in Example 1.

### Comparative Examples 4 and 5

In Comparative Example 4, a mixture made by homogenously mixing 100 grams of an iron powder, 7.5 grams of activated carbon, 3 grams of bentonite and 1 gram of CMC was mixed thoroughly with an aqueous solution of sodium chloride (comprising 4 grams of NaCl and 36 grams of water) to produce a creamy composition.

Then, the creamy composition was treated in the same manner as was the above-described sherbet-like heat-generating composition, thereby producing a heater.

The heater was subjected to a heat-generation test similar to that described above. However, the creamy composition showed a temperature characteristic similar to that in Comparative Example 3 and generated a heat, but the generation of the heat was sluggish and disqualified for a heater according to the present invention.

In Comparative Example 6, a mixture made by homogenously mixing 100 grams of an iron powder, 6 grams of activated carbon, and 8 grams of terra-balloon (having a particle size of 0.05 to 0.5 mm) which was a volcanic ash material was mixed thoroughly with an aqueous solution of sodium chloride (comprising 55 grams of NaCl and 500 grams of water) to produce a slurry-like composition.

The slurry-like composition was treated in the same manner as was the above-described sherbet-like heat-generating composition, thereby producing a heater.

The heater was subjected to a heat-generation test similar to that described above. However, the content of water in the composition was too large and hence, the generation of a heat little occurred. During the treatment, water was oozed into the entire substrate because of the too large content of water, and thus, this heater was disqualified for a heater according to the present invention.

### Example 7

A non-woven fabric 3d made at a thickness of 1 mm by spinning (1) a highly water-absorbable fiber (Runseal F made by Toyobou, Co.) resulting from the hydrolysis of an acrylic fiber by a highly concentrated alkali and having a crosslinked structure and a water-absorbing ability of 130 ml/g and (2) a polypropylene-polyethylene fiber (Melty made by Unichika, Co.) in a ratio of 50% by weight : 50% by weight was used as a support. The water-absorbable non-woven fabric 3d was cut into a size of 70 mm×120 mm, and a sherbet-like heat-generating composition (having a water mobility value of 16) 2 prepared using 100 grams of an iron powder, 10 grams of activated carbon, 7 grams of sodium chloride and 55 grams of water was molded on the cut fabric piece by a force-through die molding process. A tissue paper (pulp) 4c having the same shape of the molded composition was superposed on the molded composition. Thereafter, the resulting product was accommodated into a flat inner bag with three sides sealed, having one surface comprising a covering member including a porous polyethylene film 4a having a moisture vapor transmission rate of 400 g/m²·day and the other surface comprising a substrate formed of a laminate sheet of a polyethylene film 3b and a non-woven fabric 3f of nylon, and the remaining side was thermally sealed to produce a sheet-shaped heater (see FIG. 13). The thickness of the sheet-shaped heater was measured and as a result, was confirmed to be, 3 mm. In this state, the sheet-shaped heater was accommodated in a sealed manner into a non-permeable outer bag.

After lapse of two days, the sheet-shaped heater was taken out of the outer bag and subjected to a heat-generation test similar to that in Example 1 to provide similar results.

### Example 8

FIG. 14 shows one example of a force-through die molding process using a rubbing/cutting plate 14.

A roll film-shaped substrate 3 having a width of 130 mm and a thickness of 1 mm was matched with a molding die 11 provided at its central portion with a hole of a desired shape, and the film-shaped substrate 3 was fed horizontally at a predetermined speed between a die 10 disposed above an upper surface of the molding die 11 and a magnet 12 disposed below a lower surface of the substrate 3. The sherbet-like heat-generating composition 2 according to the present invention was fed to a punching portion of the die 11 through a hole 10a in the die 10. The heat-generating composition was rubbed and cut flush with the die 11 by a rubbing/cutting plate 14 put in front of the die 11 in a advancing direction and was accommodated into the die 11, whereby the composition 2 was molded into a desired shape having a thickness of 1 mm on the substrate 3. Thereafter, the die 11 was removed to provide a molded product laminated on the substrate 3. Thereafter, a tacky polymer comprising a styrene-isoprene-styrene block copolymer was provided in a net shape on a surface of the molded product by a melt-blow process, and a covering member was placed thereon. The peripheral portion of the molded product was sealed by a heat sealing, and a portion around the sealed peripheral portion was cut away to provide a heater having a desired shape.

This heater according to the present invention was fed to a wrapping step and accommodated in a sealed manner into an outer bag having an air-tightness.

What is claimed is:

1. A heat-generating composition comprising, as requisite components, an exothermic substance suitable to react with oxygen to generate a heat, a carbon component, an oxidation promoter and water, so that the water mobility value is in a range of 7 to 50.

2. A heat-generating composition according to claim 1, further including a volcanic ash material incorporated in said heat-generating composition.

3. A heat-generating composition according to claim 1, further including a water-retaining agent incorporated in said heat-generating composition.

4. A heat-generating composition according to claim 1, further including at least one component selected from a pH adjustor, a hydrogen inhibitor, a surfactant, an antifoaming agent, a hydrophobic polymer compound, a pyroelectric material, a far infrared ray emitting substance, an antioxidant, an aggregate and a heat-generating assistant, which is incorporated in said heat-generating composition.

5. A heat-generating composition according to claim 4, wherein said hydrophobic polymer compound is a polymer compound having an angle of contact with water equal to or larger than 40°.

6. A heater comprising a heat-generating composition according to claim 1, which is accommodated sealedly in a stratified configuration in an accommodating bag having an air-permeability at least partially, and a portion of water in said heat-generating composition is absorbed into said accommodating bag.

7. A heater according to claim 6, wherein said accommodating bag comprises a substrate in the form of a film, a sheet or a non-woven fabric and a covering member in the form of a film, a sheet or a non-woven fabric, at least a portion of said substrate or said covering member having an air-permeability and a water-absorbability.

8. A heater comprising a heat-generating composition according to claim 1, which is accommodated in an accommodating bag in a state in which it has been laminated on a underlay member, said accommodating bag being comprised of a substrate and a covering member, at least a portion of said components constituting said accommodating bag having an air-permeability.

9. A heater according to claim 8, wherein said heat-generating composition is accommodated in said accommodating bag in a state in which at least a portion of water in said heat-generating composition has been discharged to an extent substantially enough to be able to generate a heat in the atmospheric air, in at least one of such a manner that said composition is left to stand in a space, or compressed, depressurized or compressed and depressurized, and such a manner that the water is absorbed by a material such as the water-absorbable substrate or by a water absorbent, after the lamination of said heat-generating composition on said underlay member in the form of a film, a sheet or a non-woven fabric.

10. A heater according to claim 6 or 7, further including at least one component selected from an iron powder, a carbon component, a water absorbent, a water-absorbable polymer, a binder, a thickener and a coagulation assistant, which is laminated or scattered on one side or opposite sides of said heat-generating composition.

11. A heater according to claim 6 or 7, wherein at least a portion of the surface of said heat-generating composition is covered with a network polymer.

12. A heater according to claim 6 or 7, wherein said substrate and said covering member are sealed entirely or partially at a peripheral portion of said heat-generating composition in a stuck manner, an adhered manner or a thermally fused manner.

13. A heater according to claim 6 or 7, wherein said substrate and/or said covering member is formed of a water-absorbing material in the form of a film, a sheet or a non-woven fabric having a water-absorbability.

14. A heater according to claim 8, further including a water-absorbing layer formed of a water-absorbing material or a water absorbent, which is provided at least at a portion of said substrate or said covering member or said underlay member, which is in contact with said heat-generating composition.

15. A heater according to claim 8 or 14, wherein each of said substrate, said covering member and said water-absorbing layer has a water-absorbing power equal to or larger than 1 g/m².

16. A heater according to claim 8, wherein at least one of said substrate, said covering member and said underlay member has a stretching property.

17. A heater according to claim 6 or 7, wherein the whole or a portion of a surface layer of said heat-generating composition is formed into a rugged shape.

18. A heater according to claim 17, wherein the rugged shape is formed by grooves or holes of a continuous or non-continuous pattern, or a combination of them.

19. A heater according to claim 6 or 7, wherein the whole or a portion of at least said heat-generating composition and a surface layer of a material to which said heat-generating composition is laminated, is formed into a rugged shape.

20. A heater according to claim 19, wherein the rugged shape is formed by grooves or holes of a continuous or non-continuous pattern, or a combination of them.

21. A heater according to claim 6 or 7, further including a self-adhesive layer or a gel layer laminated at least on a portion of an exposed surface of either said substrate or said covering member.

22. A heater according to claim 21, wherein said self-adhesive layer or said gel layer is a wet compress layer containing a wet compress drug, or a drug-containing layer containing or carrying an endermically absorbable drug.

23. A process for producing a heater, comprising the steps of subjecting a heat-generating composition according to claim 1 to a molding such as the lamination on at least one predetermined region on a substrate in the form of a film, a sheet or a non-woven fabric, and placing a covering member in the form of a film, a sheet or a non-woven fabric to cover said heat-generating composition, so that at least a portion of the said substrate or said covering member has an air-permeability.

24. A process for producing a heater, comprising the steps of laminating a heat-generating composition according to claim 1 on at least one predetermined region on a substrate in the form of a film, a sheet or a non-woven fabric, laminating or scattering at least one component selected from an iron powder, a carbon component, a ceramic powder emitting far infrared rays, a fiber emitting far infrared rays, a water absorbent, a water-absorbing material, a water-absorbable polymer, a binder, a thickener and a coagulation assistant on at least one of upper and lower surfaces of said heat-generating composition, and placing a covering member in the form of a film, a sheet or a non-woven fabric to cover said heat-generating composition and the at least one component selected from the iron powder, the carbon component, the ceramic powder emitting far infrared rays, the fiber emitting far infrared rays, the water absorbent, the water-absorbing material, the water-absorbable polymer, the binder, the thickener and the coagulation assistant, so that at least a portion of said substrate or said covering member has an air-permeability.

25. A process for producing a heater, comprising the steps of laminating a heat-generating composition according to claim 1 on a substrate in the form of a film, a sheet or a non-woven fabric, placing a network polymer on said heat-generating composition, placing a covering member in the form of a film, a sheet or a non-woven fabric on the network polymer, affixing said substrate and said covering member to each other by said network polymer, and punching the resulting laminate into any shape, so that at least a portion of said substrate or said covering member has an air-permeability.

26. A process for producing a heater, comprising the steps of laminating a heat-generating composition according to claim 1 on a member in the form of a non-woven fabric, covering the resulting laminate by a member in the form of a non-woven fabric, dehydrating said heat-generating composition in a sucking, centrifugal, compressing, depressurizing, or compressing and depressurizing manner and affixing said members to each other to provide a laminate, punching said laminate into any shape, placing said laminate on a substrate, placing a covering member in the form of a film, a sheet or a non-woven fabric onto said laminate, fusing said substrate and said covering member to each other at their peripheral portions, and punching the resulting laminate into any shape, so that at least a portion of said substrate or said covering member has an air-permeability.

27. A process for producing a heater, comprising the steps of interposing a heater according to claim 6 or 7 between two films or sheets, punching said two films or sheets into a size larger than that of the heater simultaneously with or after said interposition, and sealing said two films or sheets at a peripheral edge of the heater simultaneously with or after said punching.
